(19) United States
(12) Patent Application Publication
(10) Pub. No.: US 2025/0046863 A1
(43) Pub. Date: Feb. 6, 2025

(54) COMPOSITE FOR SOLID ELECTROLYTE OF SODIUM ALL-SOLID-STATE BATTERY, SODIUM ALL-SOLID-STATE BATTERY, AND METHOD FOR PREPARING THE SAME

(71) Applicant: UIF (University Industry Foundation), Yonsei University, Seoul (KR)

(72) Inventors: Yoon Seok Jung, Seoul (KR); Juhyoun Park, si (KR); Jun Pyo Son, Seoul (KR); Hiram Kwak, Seoul (KR)

(21) Appl. No.: 18/792,751

(22) Filed: Aug. 2, 2024

(30) Foreign Application Priority Data
Aug. 3, 2023 (KR) 10-2023-0101789
May 2, 2024 (KR) 10-2024-0058715

(51) Int. Cl. H01M 10/0562; H01M 10/054; H01M 50/403; H01M 50/431

(52) U.S. Cl. CPC H01M 10/0562; H01M 10/054; H01M 50/403; H01M 50/431; H01M 2300/008

(57) ABSTRACT

Disclosed are a composite for a solid electrolyte for a sodium all-solid-state battery, sodium all-solid-state battery, and a method of manufacturing them, the composite including sodium metal tetrachloride (NaMCl₄), wherein the metal (M) represents a Group 13 element on the periodic table, and the composite includes an amorphous phase.

### CROSS-REFERENCE TO RELATED APPLICATION

This application claims priority to and the benefit of Korean Patent Application No. 10-2023-0101789 filed in the Korean Intellectual Property Office on Aug. 3, 2023, and Korean Patent Application No. 10-2024-0058715 filed in the Korean Intellectual Property Office on May 2, 2024, the entire contents of which are incorporated herein by reference.

### BACKGROUND OF THE INVENTION

### (a) Field of the Invention

The present disclosure relates to a composite for a solid electrolyte for a sodium all-solid-state battery, a sodium all-solid-state battery, and a method of manufacturing them.

### (b) Description of the Related Art

Currently widely commercialized lithium ion batteries use an organic liquid electrolyte. However, the lithium ion batteries have a serious safety problem, because they may easily catch fire with just single spark, but once the fire starts, the fire is uncontrollable.

In fact, frequent fire accidents have not only been reported on an energy storage system (ESS) to which the lithium ion batteries are applied, but also a price of lithium nearly 10 times increases over the past 10 years due to the rapidly-increasing demand for the batteries, which is increasing an interest in sodium-ion batteries.

The sodium-ion batteries use a sodium solid electrolyte, which is a non-flammable inorganic material including sodium as a primary component, wherein the sodium is the 6^{th} most abundant element on the Earth's surface and free from concerns about reserves. Accordingly, the sodium all-solid-state batteries to which this is applied may be applied to ESS as next generation batteries capable of safely-storing energy at a lower price than the conventional lithium ion batteries.

However, sodium all-solid-state batteries developed so far have a problem that a solid electrolyte is expensive. In addition, in order to realize high energy density, because it is essential to operate the batteries at a high voltage of about 3 to about 4 V or more, the most of them have a serious decomposition reaction at the high voltage, failing in implementing performance.

The solid electrolyte conducts ions between positive and negative electrodes and simultaneously, acts as a separator blocking a physical contact thereof. Compared to a liquid electrolyte, in general, a solid electrolyte exhibits low ionic conductivity at room temperature and particularly, has difficulties in effectively maintaining the positive electrode-electrolyte interface due to volume changes according to intercalation and deintercalation of cations.

Previously, lots of research on sodium all-solid-state batteries using sulfide-based materials has been made, but the sulfide-based materials are difficult to be used for a 3 V class positive electrode. Accordingly, a new positive electrode active material dedicated for a high voltage to be able to withstand the high voltage is required, and a halide-based solid electrolyte is emerging as an alternative.

### PRIOR ART

### Patent Document

(Patent Document 0001) Korean Patent Publication No. 10-1982539

(Patent Document 0002) Chinese Patent Publication No. 115000499A

### SUMMARY OF THE INVENTION

According to some example embodiments, provided is a composite for a solid electrolyte for a sodium all-solid-state battery that solves problems of low conductivity (10⁻⁶ Scm⁻¹) and side reaction with sulfide-based solid electrolyte at high voltage and high temperature, which is a problem of the positive electrode electrolyte NaAlCl₄ of the conventional sodium all-solid-state battery, and also provided are a sodium all-solid-state battery including the same, and a method for manufacturing the same.

An embodiment provides a composite for a solid electrolyte for a sodium all-solid-state battery including sodium metal tetrachloride (NaMCl₄), wherein the metal (M) represents a Group 13 element on the periodic table, and the composite includes an amorphous phase.

Another embodiment provides a sodium all-solid-state battery including the composite for a solid electrolyte for a sodium all-solid-state battery.

Another embodiment provides a method for manufacturing composite for a solid electrolyte for a sodium all-solid-state battery which includes performing a ball milling for a mixture of sodium fluoride (NaF) and metal chloride (MCl₃), wherein the metal (M) of the metal chloride (MCl₃) is a Group 13 element of the periodic table.

Another embodiment provides a method for manufacturing a sodium all-solid-state battery, including a method for manufacturing the composite for a solid electrolyte for a sodium all-solid-state battery.

The composite for a solid electrolyte for a sodium all-solid-state battery according to an embodiment is a composite for a solid electrolyte for a sodium all-solid-state battery including an amorphous phase. It has a higher conductivity than NaAlCl₄ manufactured by ball milling conventional NaCl—AlCl₃, and has a stable effect due to low side reactions with sulfide-based solid electrolytes.

### BRIEF DESCRIPTION OF THE DRAWINGS

FIG. 1 shows the results of XRD analysis of the solid electrolytes of Examples A1 to A4 and Comparative Example O according to Experimental Example 1.

FIG. 2 shows the results of F MAS NMR analysis of the solid electrolytes of Examples A1 to A4 according to Experimental Example 1 to confirm the presence of fluorine (F).

FIG. 3 shows the results of XPS analysis of the solid electrolyte of Example A4 according to Experimental Example 1.

FIG. 4 shows the ionic conductivity measurement results for the solid electrolytes of Examples A2 to A4 and Comparative Example O according to Experimental Example 2.

FIG. 5 shows the ionic conductivity measurement results of Experimental Example 2 as a contour map.

FIG. 6 shows an Arrhenius plot according to Experimental Example 2.

FIG. 7 shows a Nyquist plot of Example D2 according to Experimental Example 2.

FIG. 8 shows a Nyquist plot of Example A4 according to Experimental Example 2.

FIG. 9A shows the results of cyclic voltammetry measurement of Device Comparative Example 1 (NAC Bi-layer) and Device Comparative Example 2 (NAC Mono-layer) according to Experimental Example 3.

FIG. 9B shows the results of cyclic voltammetry measurement of Device Example 1 (NACF A4 Bi-layer) and Device Example 2 (NACF A4 Mono-layer) according to Experimental Example 3.

FIG. 10A shows the results of the voltage step half-cell test of Device Example 4 (NACF A4 Mono-layer) and Device Comparative Example 4 (NAC Mono-layer) according to Experimental Example 4.

FIG. 10B shows the results of the voltage step half-cell test of Device Example 3 (NACF A4 Bi-layer) and Device Comparative Example 3 (NAC Bi-layer) according to Experimental Example 4.

FIG. 11 shows the results of measuring the effect on NAC-NPS side reactions according to temperature in Experimental Example 5.

FIG. 12 is a charge/discharge curve of a single solid electrolyte layer half-cell according to Experimental Example 5.

FIG. 13 shows the impedance analysis results of Experimental Example 6.

FIG. 14 is an equivalent circuit model used in the impedance analysis of Experimental Example 6.

FIG. 15 is an analysis result of R₁+R₂ resistance over time in the CV cells of FIGS. 13(a) to 13(d) according to Experimental Example 6.

FIG. 16 is an analysis result of R₃ resistance over time in the CV cells of FIGS. 13(a) to 13(d) according to Experimental Example 6.

FIG. 17A shows the analysis results of cycle characteristics performance and corresponding voltage profile under conditions of 30° C. and 0.2 C in Experimental Example 7.

FIG. 17B shows the analysis results of discharge capacity and coulombic efficiency according to cycle under conditions of 30° C. and 0.2 C in Experimental Example 7.

FIG. 18A shows the analysis results of cycle characteristics performance and corresponding voltage profile under conditions of 60° C. and 1.0 C in Experimental Example 7.

FIG. 18B shows the analysis results of discharge capacity and coulombic efficiency according to cycle under conditions of 60° C. and 1.0 C in Experimental Example 7.

FIG. 19 is an evaluation result comparing the cell performance of the NACF of Experimental Example 7 with that of a state-of-the-art ASNB employing a 3V or 4V class layered oxide Na cathode.

FIG. 20 shows the Raman spectroscopy measurement results for the solid electrolytes of Examples A1 to A4 and Comparative Example O according to Experimental Example 9.

FIG. 21 shows the results of XRD analysis of the solid electrolytes of Examples B1 to B4 and Comparative Example O according to Experimental

Example 10.

### DETAILED DESCRIPTION OF THE EMBODIMENTS

Hereinafter, various aspects and various embodiments of the present invention are described in more detail. Hereinafter, embodiments of the present invention will be described in detail with reference to the attached drawings so that those skilled in the art can easily implement the present invention. However, the following description is not intended to limit the present invention to specific embodiments, and in describing the present invention, if it is determined that a detailed description of related known technology may obscure the gist of the present invention, the detailed description will be omitted. The terminology used herein is only used to describe specific embodiments and is not intended to limit the invention. Singular expressions include plural expressions unless the context clearly dictates otherwise. In this application, terms such as “comprise” or “have” are intended to designate the presence of features, numbers, steps, operations, components, or a combination thereof described in the specification, but it should be understood that this does not exclude in advance the presence or addition of one or more other features, numbers, steps, operations, components, or a combination thereof.

In the drawings, the thickness of layers, films, panels, regions, etc., are exaggerated for clarity. It will be understood that when an element such as a layer, film, region, or substrate is referred to as being “on” another element, it may be directly on the other element or intervening elements may also be present. In contrast, when an element is referred to as being “directly on” another element, there are no intervening elements present.

In order to clearly explain the present embodiment in the drawings, parts not related to the description are omitted, and the same reference numerals are used for identical or similar components throughout the specification.

Hereinafter, the terms “lower” and “upper” are used for convenience of explanation and do not limit the positional relationship.

Hereinafter, unless otherwise defined, ‘metal’ includes metal, metalloid, transition metal, post-transition metal, and semimetal.

Hereinafter, a composite for a solid electrolyte for a sodium all-solid-state battery, which is an embodiment, will be described.

In addition, the composite for a solid electrolyte for a sodium all-solid-state battery according to an embodiment is a composite including sodium metal tetrachloride (NaMCl₄), wherein the metal (M) represents a Group 13 element on the periodic table, and the composite includes an amorphous phase.

As a solid electrolyte used in sodium all-solid-state batteries, the sulfide-based solid electrolyte studied previously is not suitable for high voltages of 3V class or higher, and thus halide-based solid electrolyte is being studied.

The halide-based solid electrolytes are considered as an alternative because they can withstand high voltages, but they have the disadvantage of being uneconomical as they require the use of rare and expensive elements such as Er and Y. Accordingly, the present inventors have recently developed an economical solid electrolyte NaAlCl₄ using inexpensive elements such as Al, but the problem of NaAlCl₄ having low ionic conductivity and side reactions with sulfide-based solid electrolytes under high voltage or high temperature conditions is newly discovered.

Accordingly, the present inventors propose a composite for a solid electrolyte for a sodium all-solid-state battery which can withstand 3V or higher, and thus can be used appropriately even under high voltage conditions, ensures cost-effectiveness by not requiring the use of expensive elements, also has excellent ionic conductivity and does not cause side reactions with sulfide-based solid electrolytes under high voltage or high temperature conditions, and also propose a sodium all-solid-state battery, and a method of manufacturing them.

In order to achieve these, the composite for a solid electrolyte for a sodium all-solid-state battery includes sodium metal tetrachloride (NaMCl₄), and the composite includes an amorphous phase.

The sodium and Group 13 element on the periodic table, which is a metal (M) including aluminum, included in the solid electrolyte composite for a sodium all-solid-state battery according to an embodiment, are easy to obtain because they have abundant reserves compared to Li, Er, Y, etc., and the unit price is relatively low. Therefore, the composite for a solid electrolyte for a sodium all-solid-state battery according to an embodiment has the advantage of being mass-produced while reducing industrial costs by reducing manufacturing costs compared to conventional solid electrolytes using Li, Er, Y, etc.

In addition, the halogen element can ensure excellent ionic conductivity and improve atmospheric stability. Accordingly, the composite for a solid electrolyte for a sodium all-solid-state battery according to an embodiment including the halogen element can also secure excellent atmospheric stability (or oxidation stability) compared to the conventional sulfide-based solid electrolyte.

As an example, the composite for a solid electrolyte for a sodium all-solid-state battery may further include sodium fluoride (NaF). According to an embodiment, the composite for a solid electrolyte for a sodium all-solid-state battery may exist within the composite without losing the characteristics of sodium metal tetrachloride (NaMCl₄) and sodium fluoride (NaF). Therefore, while securing economic feasibility due to sodium metal tetrachloride (NaMCl₄), side reactions with the sulfide-based solid electrolyte can be suppressed under high voltage and high temperature conditions due to sodium fluoride (NaF).

In an embodiment, the metal (M) of the sodium metal tetrachloride (NaMCl₄) may include boron (B), aluminum (AI), gallium (Ga), indium (In), thallium (TI), nihonium (Nh), or a combination thereof. Alternatively, the metal (M) of the sodium metal tetrachloride (NaMCl₄) may include boron (B), aluminum (AI), gallium (Ga), or a combination thereof, or may be aluminum (Al). By meeting this requirement, it is more easily available than conventional halide-based solid electrolytes, and not only can it be economically feasible, but it can also be used appropriately under high voltage conditions.

As an example, the sodium metal tetrachloride (NaAlCl₄) may be sodium aluminum tetrachloride (NaAlCl₄). If this is met, it may be more advantageous to secure economic efficiency and cycle characteristics under high voltage conditions.

The composite for a solid electrolyte for a sodium all-solid-state battery includes an amorphous phase. The amorphous phase can contribute to improving ionic conductivity and suppressing side reactions with sulfide-based solid electrolytes under high voltage or high temperature conditions. Through this, not only can it be used appropriately by stably implementing cycle characteristics under high voltage conditions, but also reducing resistance.

In an embodiment, the composite for a solid electrolyte for a sodium all-solid-state battery has a peak in a range of about −30 ppm to about −250 ppm (for example, about −50 ppm to about −250 ppm) due to the amorphous phase in ¹⁹F MAS NMR analysis. By satisfying this, excellent ionic conductivity, cycle characteristics, and capacity retention rate under high voltage conditions can be secured.

In an embodiment, the amorphous phase may include fluorine (F), or the amorphous phase may include the aforementioned metal (M), for example, aluminum (Al). As an example, the amorphous phase may include an M—F bond, and a representative example may include an Al—F bond. If this is satisfied, ionic conductivity can be improved. The composite for a solid electrolyte for a sodium all-solid-state battery can form a crosslinked network with an M—F—M (or Al—F—Al) structure that provides mobility to Na⁺ ions by including M—F (or Al—F) bonds in the amorphous phase. Through this crosslinked network, Na⁺ ions can move effectively and the effect of improving ionic conductivity can be maximized.

For example, the amorphous phase may include a bridging fluorine structure, and the M—F (Al—F) bond included in the amorphous phase may exist in a bridging fluorine structure. Alternatively, F in the M—F bond may correspond to bridging fluorine, and F in the M—F bond may have a bridging fluorine structure represented by Chemical Formula A. If this is satisfied, the effect of improving ionic conductivity can be maximized by effectively forming a crosslinked network by M—F bonding, and at the same time, the resistance of the battery can be clearly lowered.

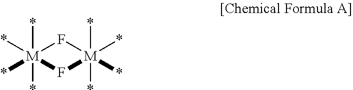

In Chemical Formula A, the definition of M is the same as described above, and the * mark indicates a position linked to another element.

In an embodiment, the composite for a solid electrolyte for a sodium all-solid-state battery has a peak with a median value in the range of about −130 ppm to about −150 ppm due to the M—F bond (e.g., Al—F bond) in ¹⁹F MAS NMR analysis. For example, the median values of the peaks may be about −133 ppm to about −148 ppm, about −134 ppm to about −148 ppm, about −135 ppm to about −146 ppm, about −134.9 ppm to about −146 ppm, about −134.96 ppm to about −145.63 ppm, about −138 ppm to about −145.63 ppm, about −138.73 ppm to about −145.63 ppm, about −140 ppm to about −145.63 ppm, or about −145 ppm to about −145.63 ppm. If this is satisfied, excellent ionic conductivity, cycle characteristics, and capacity retention rate under high voltage conditions can be secured.

For example, a full width at half maximum (FWHM) of the peak may be about 80 ppm to about 95 ppm, for example, the full width at half maximum of the peak may be about 83 ppm to about 94 ppm, about 83.4 ppm to about 93.9 ppm, about 83.46 ppm to about 93 ppm, about 84.0 ppm to about 93.0 ppm, or about 84.91 ppm to about 92.17 ppm. If this is satisfied, not only can cycle characteristics be stably implemented under high voltage conditions and can be used appropriately, but resistance can also be effectively reduced.

In an embodiment, the amorphous phase may increase as an amount of the sodium fluoride (NaF) increases. As the ratio (or amount) of this amorphous phase increases, the ionic conductivity of the composite can be improved.

For example, the coordination number of aluminum (Al) to which fluorine (F) is bonded in the amorphous phase may be 5 to 6. If this is satisfied, excellent ionic conductivity, cycle characteristics, and capacity retention rate under high voltage conditions can be secured.

As an example, the composite may include about 10 parts by mole to about 150 parts by mole of sodium fluoride (NaF) based on 100 parts by mole of sodium metal tetrachloride (NaMCl₄).

As an example, the composite may include about 50 wt % to about 90 wt %, for example about 60 wt % to about 85 wt %, about 65 wt % to about 83 wt %, or about 69.3 wt % to about 83.9 wt % of amorphous phase material, based on a total weight of the composite (i.e., 100 wt % of the composite). If this is satisfied, the ionic conductivity of the composite can be further improved, cycle characteristics can be stably implemented under high voltage conditions, and not only can it be used appropriately, but the resistance of the battery can be effectively reduced.

As an example, the ionic conductivity of the composite for a solid electrolyte for a sodium all-solid-state battery may be about 7.5×10⁻⁶ S/cm to about 5.0×10⁻⁵ S/cm, for example about 7.8×10⁻⁶ S/cm to about 3.1×10⁻⁵ S/cm, about 7.80×10⁻⁶ S/cm to about 5.0×10⁻⁵ S/cm, about 7.80×10⁻⁶ S/cm to about 3.08×10⁻⁵ S/cm, about 1.0×10⁻⁵ S/cm to about 5.0×10⁻⁵ S/cm, about 2.5×10⁻⁵ S/cm to about 5.0×10⁻⁵ S/cm, about 3.0×10⁻⁵ S/cm to about 4.0×10⁻⁵ S/cm, or about 3.0×10⁻⁵ S/cm to about 3.5×10⁻⁵ S/cm at 30° C.

An embodiment provides a sodium all-solid-state battery including the composite for a solid electrolyte for a sodium all-solid-state battery.

As an example, the sodium all-solid-state battery includes a positive electrode layer; a negative electrode layer; and a solid electrolyte layer between the positive electrode layer and the negative electrode layer; wherein at least one of the positive electrode layer, negative electrode layer, and solid electrolyte layer may include the composite for a solid electrolyte for a sodium all-solid-state battery. If this is satisfied, the ionic conductivity of Na can be improved and side reactions under high voltage conditions can be suppressed.

In an embodiment, the solid electrolyte layer may include a positive electrode electrolyte layer on the positive electrode layer and a negative electrode electrolyte layer on the negative electrode layer, wherein the composite for a solid electrolyte for a sodium all-solid-state battery may be included in at least one of the positive electrode layer and positive electrode electrolyte layer. If this is satisfied, Na conductivity can be improved and side reactions under high voltage conditions can be suppressed.

As an example, the composite for a solid electrolyte for a sodium all-solid-state battery may be included in both the positive electrode layer and the positive electrode electrolyte layer. If this is met, an effect of suppressing side reactions under high voltage conditions can be maximized, effectively reducing resistance, and contributing to improving cycle-life characteristics at high voltage.

In an embodiment, a sodium all-solid-state battery including a composite for solid electrolyte has a discharge capacity of about 80 mA h/g to about 120 mA h/g at 60° C. and 1 C, and a capacity retention rate of about 70% to about 95% after 200 cycles at 30° C. and 0.2 C. These measurements may be the result of using P2 type Na_{0.66}Ni_{0.1}Co_{0.1}Mn_{0.8}O₂ as the positive electrode active material and Na₃Sn as the negative electrode material and operating at a voltage range of 1.5 to 4.2 V (vs. Na/Na⁺).

As an example, the positive electrode layer may be a layer including a positive electrode active material and may further include a solid electrolyte, a conductive material, and a binder. Herein, the positive electrode layer includes a solid electrolyte, and the solid electrolyte may include the composite for a solid electrolyte for a sodium all-solid-state battery according to the above-described embodiment.

A proportion of the composite for a solid electrolyte for a sodium all-solid-state battery included in the positive electrode layer varies depending on the type of battery, but may be, for example about 0.1 volume % to about 80 volume %, preferably about 1 volume % to about 60 volume %, or more preferably about 10 volume % to about 50 volume %.

The positive electrode active material may be a metal oxide including sodium into which sodium ions can be electrochemically inserted or desorbed through a redox reaction.

In an embodiment, the positive electrode active material may include a sodium-based composite oxide represented by Chemical Formula 1.

Naₐ₁M¹ₓ₁M²_{y1}M³_{z1}O_{2-b1}X_{b1} [Chemical Formula 1]

In Chemical Formula 1, 0.3≤a1≤1.8, 0.01≤x1≤1, 0≤y1≤0.9, 0≤z1≤0.9, 0.9≤x1+y1+z1≤1.1, and 0≤b1≤0.1, M¹, M², and M³ are each independently Al, B, Ba, Ca, Ce, Co, Cr, Fe, Ni, Mg, Mn, Mo, Nb, Si, Sr, Ti, V, W, Zr, or a combination thereof, and X is F, P, S, or a combination thereof.

For example, in Chemical Formula 1, 0.4≤a1≤1.8, 0.05≤x1≤1, and 0≤y1≤0.9, 0≤z1≤0.9, 0.5≤a1≤1.5, 0.08≤x1≤1, 0.08≤y1≤0.9, and 0.1≤z1≤0.9, or 0.6≤a1≤1.5, 0.1≤x1≤1, 0.1≤y1≤0.9, and 0.3≤z1≤0.9.

For example, the positive electrode active materials may include sodium-cobalt-based composite oxide such as NaCoO₂, sodium-nickel-based composite oxide such as NaNiO₂, sodium-manganese-based composite oxide such as NaMn₂O₄, sodium.vanadium-based composite oxide such as NaV₂O₅, or sodium-iron-based composite oxide such as NaFeO₂. Additionally, NCM material may be used as the positive electrode active material. That is, the positive electrode active material may be NaNiₓ₁CO_{y1}Mn_{z1}O₂ (x1+y1+z1=1), NaNiₓ₁Co_{y1}Mn_{z1}M_{w1}O₂ (x1+y1+z1+w1=1, 0.05≤w1≤1), wherein M is B, Al, Ga, In, Si, Ge, Sn, Pb, As, Sb, Bi, Ti, V, Cr, Mn, Fe, Co, Ni, Cu, Y, Zr, Nb, Mo, Tc, Ru, Rh, Pd, Ag, Hf, Ta, or W.

As an example, the positive electrode active material may include a sodium-based composite oxide represented by Chemical Formula 2.

Naₐ₂Niₓ₂M²_{y2}M³_{z2}O_{2-b2}X_{b2} [Chemical Formula 2]

In Chemical Formula 2, 0.3≤a2≤1.8, 0.01≤x2≤1, 0≤y2≤0.9, 0≤z2≤0.9, 0.9≤x2+y2+z2≤1.1, and 0≤b2≤0.1, M¹, M², and M³ are each independently Al, B, Ba, Ca, Ce, Co, Cr, Fe, Mg, Mn, Mo, Nb, Si, Sr, Ti, V, W, Zr, or a combination thereof, and X is F, P, S, or a combination thereof.

For example, in Chemical Formula 2, 0.4≤a2≤1.8, 0.05≤x2≤1, and 0≤y2≤0.9, 0≤z2≤0.9, 0.5≤a2≤1.5, 0.08≤x2≤1, 0.08≤y2≤0.9, and 0.1≤z2≤0.9, or 0.6≤a2≤1.5, 0.1≤x2≤1, 0.1≤y2≤0.9, and 0.3≤z2≤0.9.

Alternatively, the positive electrode active material may include a sodium-based composite oxide represented by Chemical Formula 3.

Naₐ₃Niₓ₃Co_{y3}M³_{z3}O_{2-b3}X_{b3} [Chemical Formula 3]

In Chemical Formula 3, 0.3≤a3≤1.8, 0.01≤x3≤1, 0≤y3≤0.9, 0≤z3≤0.9, 0.9≤x3+y3+z3≤1.1, and 0≤b3≤0.1, M¹, M², and M³ are each independently Al, B, Ba, Ca, Ce, Cr, Fe, Mg, Mn, Mo, Nb, Si, Sr, Ti, V, W, Zr, or a combination thereof, and X is F, P, S, or a combination thereof.

For example, in Chemical Formula 3, 0.4≤a3≤1.8, 0.05≤x3≤1, and 0≤y3≤0.9, 0≤z3≤0.9, 0.5≤a3≤1.5, 0.08≤x3≤1, 0.08≤y3≤0.9, and 0.1≤z3≤0.9, or 0.6≤a3≤1.5, 0.1≤x3≤1, 0.1≤y3≤0.9, and 0.3≤z3≤0.9.

The conductive material is not particularly limited as long as it is a conductive material used in batteries, but may include graphene, carbon nanotubes, Ketjen black, activated carbon, Super P in a powder form, Denka in a rod form, or vapor grown carbon fiber (VGCF).

The binder can generally be a polymer compound of fluorine-based, diene-based, acrylic-based, or silicone-based polymer. For example, the binder may be nitrile butadiene rubber (NBR), polytetrafluoroethylene (PTFE), polyvinylidene fluoride (PVDF), carboxymethyl cellulose (CMC), a styrene butadiene rubber (SBR), polyimide, etc.

The positive electrode layer may be manufactured by coating with a first slurry that is formed by mixing at least one of a positive electrode active material, a solid electrolyte including the aforementioned composite for a solid electrolyte for a sodium all-solid-state battery according to an embodiment, a solvent, and, if necessary, a conductive material and a binder.

A thickness of the anode layer may be, for example, about 0.1 μm to about 1000 μm.

Additionally, the negative electrode layer may be a layer including a negative electrode active material and, if necessary, may include at least one of a solid electrolyte, a conductive material, and a binder. Herein, the negative electrode layer includes a solid electrolyte, and the solid electrolyte may be a solid electrolyte including the aforementioned composite for a solid electrolyte for a sodium all-solid-state battery according to an embodiment.

A proportion of the composite for a solid electrolyte for a sodium all-solid-state battery included in the negative electrode layer varies depending on the type of battery, but may be, for example, about 0.1 volume % to about 80 volume %, about 1 volume % to about 60 volume %, or about 10 volume % to about 50 volume %.

Herein, the negative electrode layer may be manufactured through the same composition and manufacturing method as the positive electrode layer, except for the negative electrode active material. Therefore, the details are the same as the above description.

The negative electrode active material may include a metal active material and a carbon active material. The metal active materials include In, Al, Si, and Sn. Meanwhile, the carbon active material may include mesocarbon microbeads (MCMB), highly oriented graphite (HOPG), hard carbon, and soft carbon.

The negative electrode layer may be manufactured by coating a second slurry including a negative electrode active material, a solid electrolyte including the aforementioned composite for a solid electrolyte for a sodium all-solid-state battery according to an embodiment, a solvent, and, if necessary, at least one of a conductive material and a binder.

A thickness of the negative electrode layer may be, for example, about 0.1 μm to about 1000 μm.

Additionally, the solid electrolyte layer may be a layer formed between the positive electrode layer and the negative electrode layer, and may include a solid electrolyte including the composite for a solid electrolyte for a sodium all-solid-state battery according to an embodiment.

In an embodiment, a ratio of the solid electrolyte including the composite for a solid electrolyte for a sodium all-solid-state battery included in the solid electrolyte layer may be about 10 volume % to about 100 volume %, preferably about 50 volume % to about 100 volume %. For example, the solid electrolyte layer may include a positive electrode electrolyte layer on the positive electrode layer and a negative electrode electrolyte layer the negative electrode layer, wherein at least one of the positive electrode layer, the positive electrode electrolyte layer, and the negative electrode electrolyte layer may include the aforementioned composite for a solid electrolyte for a sodium all-solid-state battery.

As an example, the solid electrolyte layer may be composed solely of a solid electrolyte including the aforementioned composite for a solid electrolyte for a sodium all-solid-state battery.

A thickness of the solid electrolyte layer may be about 0.1 μm to about 1000 μm, for example about 0.1 μm to about 300 μm.

As an example, a method of forming a solid electrolyte layer may be a method of compression molding a solid electrolyte including the aforementioned composite for a solid electrolyte for a sodium all-solid-state battery, or a method of coating a third slurry formed by mixing a solid electrolyte including the aforementioned composite for a solid electrolyte for a sodium all-solid-state battery with a binder and a solvent.

In addition, the sodium all-solid-state battery may further include a positive electrode current collector for collecting current in the positive electrode layer, and a negative electrode current collector for collecting current in the negative electrode layer.

A material of the positive electrode current collector may include SUS, aluminum, nickel, iron, titanium, and carbon, and among these, SUS can be used.

Meanwhile, a material for the negative electrode current collector include SUS, copper, nickel, and carbon, and among these, SUS can be used.

There is no particular limitation on the thickness or shape of the positive electrode current collector and the negative electrode current collector, and they can be appropriately selected depending on the purpose of the battery, etc.

In addition, the sodium all-solid-state battery may further include a battery case for storing it. As the battery case, a general battery case can be used, for example, a SUS battery case, etc.

The shape of the battery of an embodiment may include a coin shape, a laminate shape, a cylindrical shape, and a square shape. Additionally, the method of manufacturing the battery of an embodiment is not particularly limited as long as it can obtain the battery described above, and the same method as the manufacturing method of a general battery can be used. For example, the method may include sequentially pressing the material constituting the positive electrode layer, the material constituting the solid electrolyte layer, and the material constituting the negative electrode layer, then storing them inside the battery case, and caulking the battery case.

An embodiment provides a method for manufacturing a composite for a solid electrolyte for a sodium all-solid-state battery. A method of manufacturing a composite for a solid electrolyte for a sodium all-solid-state battery according to an embodiment includes performing ball milling on a mixture of sodium fluoride (NaF) and metal chloride (MCl₃).

The metal (M) of the metal chloride (MCl₃) represents a Group 13 element on the periodic table. For example, the metal (M) of the metal chloride (MCl₃) may include boron (B), aluminum (Al), gallium (Ga), indium (In), thallium (Tl), nihonium (Nh), or a combination thereof.

As an example, the metal chloride (MCl₃) may be boron chloride (BCl₃), aluminum chloride (AlCl₃), gallium chloride (GaCl₃), indium chloride (InCl₃), thallium chloride (TlCl₃), nihonium chloride (NhCl₃), or a combination, and as a representative example, the metal chloride (MCl₃) may be aluminum chloride (AlCl₃).

The mixture may include about 10 parts by mole to about 200 parts by mole of metal chloride (MCl₃), for example, about 30 parts by mole to about 150 parts by mole, or about 40 parts by mole to about 120 parts by mole based on 100 parts by mole of sodium fluoride (NaF). When the above range is satisfied, ionic conductivity can be improved.

Optionally, sodium chloride (NaCl) may be additionally mixed into the mixture.

In an embodiment, the mixture may include about 30 parts by mole to about 200 parts by mole of metal chloride (MCl₃) and about 5 parts by mole to about 200 parts by mole of sodium chloride (NaCl) based on 100 parts by mole of sodium fluoride (NaF). For example, the mixture may include about 45 parts by mole to about 185 parts by mole of metal chloride (MCl₃), about 10 parts by mole to about 185 parts by mole of sodium chloride (NaCl), about 60 parts by mole to about 170 parts by mole of aluminum chloride (AlCl₃), or about 15 parts by mole to about 170 parts by mole of sodium chloride (NaCl) based on 100 parts by mole of sodium fluoride (NaF). When the above range is satisfied, the effect of improving ionic conductivity can be maximized.

The ball mill is a dry method and a mechanical milling method corresponding to solid-phase mixing. The mechanical milling is a method of pulverizing a sample while applying mechanical energy to it. When the heat treatment is performed other than the ball mill, new sodium sites (Na2) are not created, so it may be preferable to perform the heat treatment by the ball mill.

Various conditions of the ball mill can be set so that new sodium sites (Na2) can be formed.

In an embodiment, the ball mill may be performed in an inert gas atmosphere, for example, in an argon (Ar) gas atmosphere.

In an embodiment, the ball may be a zirconia (ZrO₂) ball. For example, ball milling may be performed at a speed of about 100 rpm to about 900 rpm using a ball having a diameter of about 5 mm to about 15 mm.

As an example, a diameter of the ball during the ball mill may be about 7 mm to about 15 mm, for example, about 8 mm to about 13 mm, or about 10 mm to about 13 mm.

For example, the speed of the ball mill may be about 400 rpm to about 800 rpm, about 550 rpm to about 700 rpm, or about 600 rpm to about 700 rpm.

As an example, the ball milling may be performed for about 1 hour to about 15 hours, for example, about 5 hours to about 13 hours, about 8 hours to about 12 hours, or about 10 hours to about 12 hours, under conditions that meet the above-described ball diameter and speed.

As an example, the ball milling may be performed at a temperature of about 5° C. to about 60° C., for example, about 10° C. to about 50° C., or about 20° C. to about 40° C. According to an embodiment, the ball milling method for the composite for a solid electrolyte for a sodium all-solid-state battery is not subjected to additional heat treatment. When heat treatment is performed, ionic conductivity may be significantly reduced.

Additionally, an embodiment provides a method of manufacturing a sodium all-solid-state battery, including the method of manufacturing the composite for a solid electrolyte for a sodium all-solid-state battery. Herein, methods known in the art can be equally applied to the manufacturing method of the sodium all-solid-state battery.

Hereinafter, the present invention will be described in detail through examples.

### EXAMPLES

### Comparative Example O: NAC Solid Electrolyte

An NAC solid electrolyte including NaAlCl₄ was obtained by mixing sodium chloride (NaCl; 99.99%, Sigma Aldrich Co., Ltd.) and aluminum chloride (AlCl₃; 99.99%, Alfa Aesar) in a mole ratio of 0.5:0.5 and then, ball-milling the mixture with ZrO₂ balls (ϕ=10 mm) under argon (Ar) gas at 600 rpm for 10 hours at 25° C. by using Pulverisette 7 PL (Fritsch GmbH).

### Example A1: NACF Solid Electrolyte

An NACF solid electrolyte was obtained by mixing sodium chloride (NaCl; 99.99%, Sigma Aldrich Co., Ltd.), sodium fluoride (NaF; 99.9%, Sigma Aldrich Co., Ltd.), and aluminum chloride (AlCl₃; 99.99%, Alfa Aesar) in a molar ratio of 0.375:0.125:0.5 and then, ball-milling the mixture under argon gas by using ZrO₂ balls (ϕ=10 mm) at 600 rpm for 10 hours at 25° C.

### Example A2: NACF Solid Electrolyte

An NACF solid electrolyte was obtained in the same manner as in Example A1 except that sodium chloride (NaCl; 99.99%, Sigma Aldrich Co., Ltd.), sodium fluoride (NaF; 99.9%, Sigma Aldrich Co., Ltd.), and aluminum chloride (AlCl₃; 99.99%, Alfa Aesar) were mixed in a molar ratio of 0.25:0.25:0.5 and then, ball-milled.

### Example A3: NACF Solid Electrolyte

An NACF solid electrolyte was obtained in the same manner as in Example A1 except that sodium chloride (NaCl; 99.99%, Sigma Aldrich Co., Ltd.), sodium fluoride (NaF; 99.9%, Sigma Aldrich Co., Ltd.), and aluminum chloride (AlCl₃; 99.99%, Alfa Aesar) were mixed in a molar ratio of 0.125:0.375:0.5 and then, ball-milled.

### Example A4: NACF Solid Electrolyte

An NACF solid electrolyte was obtained in the same manner as in Example A1 except that sodium chloride (NaCl; 99.99%, Sigma Aldrich Co., Ltd.), sodium fluoride (NaF; 99.9%, Sigma Aldrich Co., Ltd.), and aluminum chloride (AlCl₃; 99.99%, Alfa Aesar) were mixed in a molar ratio of 0:0.5:0.5 and then, ball-milled.

### Example B1: NACF Solid Electrolyte

An NACF solid electrolyte was obtained in the same manner as in Example A1 except that sodium chloride (NaCl), sodium fluoride (NaF), and aluminum chloride (AlCl₃) were mixed in a molar ratio of 0.4545:0.0909:0.4545 and then, ball-milled.

### Example B2: NACF Solid Electrolyte

An NACF solid electrolyte was obtained in the same manner as in Example A1 except that sodium chloride (NaCl), sodium fluoride (NaF), and aluminum chloride (AlCl₃) were mixed in a molar ratio of 0.4167:0.1667:0.4167 and then, ball-milled.

### Example B3: NACF Solid Electrolyte

An NACF solid electrolyte was obtained in the same manner as in Example A1 except that sodium chloride (NaCl; 99.99%, Sigma Aldrich Co., Ltd.), sodium fluoride (NaF; 99.9%, Sigma Aldrich Co., Ltd.), and aluminum chloride (AlCl₃; 99.99%, Alfa Aesar) were mixed in a molar ratio of 0.3846:0.2308:0.3846 and then, ball-milled.

### Example B4: NACF Solid Electrolyte

An NACF solid electrolyte was obtained in the same manner as in Example A1 except that sodium chloride (NaCl; 99.99%, Sigma Aldrich Co., Ltd.), sodium fluoride (NaF; 99.9%, Sigma Aldrich Co., Ltd.), and aluminum chloride (AlCl₃; 99.99%, Alfa Aesar) were mixed in a molar ratio of 0.3571:0.2857:0.3571 and then, ball-milled.

### Example C1: NACF Solid Electrolyte

An NACF solid electrolyte was obtained in the same manner as in Example A1 except that sodium chloride (NaCl; 99.99%, Sigma Aldrich Co., Ltd.), sodium fluoride (NaF; 99.9%, Sigma Aldrich Co., Ltd.), and aluminum chloride (AlCl₃; 99.99%, Alfa Aesar) were mixed in a molar ratio of 0:0.6:0.4 and then, ball-milled.

### Example C2: NACF Solid Electrolyte

An NACF solid electrolyte was obtained in the same manner as in Example A1 except that sodium chloride (NaCl; 99.99%, Sigma Aldrich Co., Ltd.), sodium fluoride (NaF; 99.9%, Sigma Aldrich Co., Ltd.), and aluminum chloride (AlCl₃; 99.99%, Alfa Aesar) were mixed in a molar ratio of 0:0.7:0.3 and then, ball-milled.

### Example D1: NACF Solid Electrolyte

An NACF solid electrolyte was obtained in the same manner as in Example A1 except that sodium chloride (NaCl; 99.99%, Sigma Aldrich Co., Ltd.), sodium fluoride (NaF; 99.9%, Sigma Aldrich Co., Ltd.), and aluminum chloride (AlCl₃; 99.99%, Alfa Aesar) were mixed in a molar ratio of 0.1:0.495:0.405 and then, ball-milled.

### Example D2: NACF Solid Electrolyte

An NACF solid electrolyte was obtained in the same manner as in Example A1 except that sodium chloride (NaCl; 99.99%, Sigma Aldrich Co., Ltd.), sodium fluoride (NaF; 99.9%, Sigma Aldrich Co., Ltd.), and aluminum chloride (AlCl₃; 99.99%, Alfa Aesar) were mixed in a molar ratio of 0.1:0.54:0.36 and then, ball-milled.

### Example D3: NACF Solid Electrolyte

An NACF solid electrolyte was obtained in the same manner as in Example A1 except that sodium chloride (NaCl; 99.99%, Sigma Aldrich Co., Ltd.), sodium fluoride (NaF; 99.9%, Sigma Aldrich Co., Ltd.), and aluminum chloride (AlCl₃; 99.99%, Alfa Aesar) were mixed in a molar ratio of 0:0.65:0.35 and then, ball-milled.

### Example D4: NACF Solid Electrolyte

An NACF solid electrolyte was obtained in the same manner as in Example A1 except that sodium chloride (NaCl; 99.99%, Sigma Aldrich Co., Ltd.), sodium fluoride (NaF; 99.9%, Sigma Aldrich Co., Ltd.), and aluminum chloride (AlCl₃; 99.99%, Alfa Aesar) were mixed in a molar ratio of 0:0.55:0.45 and then, ball-milled.

### Example D5: NACF Solid Electrolyte

An NACF solid electrolyte was obtained in the same manner as in Example A1 except that sodium chloride (NaCl; 99.99%, Sigma Aldrich Co., Ltd.), sodium fluoride (NaF; 99.9%, Sigma Aldrich Co., Ltd.), and aluminum chloride (AlCl₃; 99.99%, Alfa Aesar) were mixed in a molar ratio of 0.5:0.3:0.2 and then, ball-milled.

### Device Example 1: Dual Solid Electrolyte Layer CV Cell (NACF A4 Bi-Layer)

Na₃PS₄ was obtained by ball-milling a stoichiometric mixture of Na₂S (Sigma Aldrich Co., Ltd., Product No. 407410) and P2S5 (Sigma Aldrich Co., Ltd., 99%, Product No. 232106), sealing the ball-milled mixture under vacuum, and heat-treating it at 270° C. for 1 hour.

In order to prepare Na₃Sn, Na metal (Sigma Aldrich, 99.9%, Product No. 483745) and Sn powder (Alfa Aeser, spherical, Product No. 43461) were mixed in a mortar.

The mixture was pressed into a pellet, heated at 850° C. for 12 hours in the air, cooled to 200° C., and moved to an Ar-charged glove box for use.

The Na₃Sn was used as a reference electrode, and as a working electrode, a composite obtained by mixing super P:SE (the solid electrolyte composite of Example A4)=2:8 in a weight ratio was used.

A dual solid electrolyte layer CV cell including the solid electrolyte composite of Example A4 had a structure of [working electrode-positive electrode electrolyte layer-negative electrode electrolyte layer-reference electrode] and specifically, a structure of [15 mg of the working electrode composite−100 mg of the NACF solid electrolyte of Example A4 (positive electrode electrolyte)−150 mg of Na₃PS₄ (SNP) (negative electrode electrolyte)−60 mg of the Na₃Sn counter electrode].

### Device Example 2: Single Solid Electrolyte Layer CV Cell (NACF A4 Mono-Layer)

A CV cell was manufactured under the same conditions as in Device Example 1 except that the single solid electrolyte layer CV cell including the solid electrolyte composite of Example A4 had a structure of [working electrode-electrolyte layer-reference electrode] and specifically, a structure of [15 mg of the working electrode composite−150 mg of Na₃PS₄ (SNP)−60 mg of the NasSn counter electrode] by excluding the positive electrode electrolyte layer composed of the NACF solid electrolyte of Example A4.

### Device Comparative Example 1: Dual Solid Electrolyte Layer CV Cell (NAC Bi-Layer)

A half-cell was manufactured under the same conditions as in Device Example 1 except that the solid electrolyte (NAC) of Comparative Example O was used instead of the solid electrolyte composite (NACF A4) of Example A4.

### Device Comparative Example 2: Single Solid Electrolyte Layer CV Cell (NAC Mono-Layer)

A half-cell was manufactured under the same conditions as in Device Example 2 except that the solid electrolyte (NAC) of Comparative Example O was used instead of the solid electrolyte composite (NACF A4) of Example A4.

### Device Example 3: Dual Solid Electrolyte Layer Half-Cell (NACF A4 Bi-Layer)

A half-cell was manufactured under the same conditions as in Device Example 1 except that a composite prepared by mixing Na_{0.66}Ni_{0.1}Co_{0.1}Mn_{0.8}O₂:SE (the solid electrolyte NACF of Example A4):super P=50:50:3 in a weight ratio was used instead of the composite prepared by mixing super P:SE (the solid electrolyte NACF of Example A4)=2:8 in a weight ratio as the working electrode.

### Device Example 4: Single Solid Electrolyte Layer Half-Cell (NACF A4 Mono-Layer)

A half-cell was manufactured under the same conditions as in Device Example 2 except that a composite prepared by mixing Na_{0.66}Ni_{0.1}Co_{0.1}Mn_{0.8}O₂:SE (the solid electrolyte NACF of Example A4): super P=50:50:3 in a weight ratio was used instead of the composite prepared by mixing by mixing super P:SE (the solid electrolyte NACF of Example A4)=2:8 in a weight ratio as the working electrode.

Device Comparative Example 3: Dual Solid Electrolyte Layer Half-Cell (NAC Bi-Layer)

A half-cell was manufactured under the same conditions as in Device Comparative Example 1 except that a composite prepared by mixing Na_{0.66}Ni_{0.1}Co_{0.1}Mn_{0.8}O₂:SE (the solid electrolyte NAC of Comparative Example O):super P=50:50:3 in a weight ratio was used instead of the composite prepared by mixing by mixing super P: SE (the solid electrolyte NAC of Comparative Example O)=2:8 in a weight ratio as the working electrode.

### Device Comparative Example 4: Single Solid Electrolyte Layer Half-Cell (NAC Mono-Layer)

A half-cell was manufactured under the same conditions as in Device Comparative Example 2 except that a composite prepared by mixing Na_{0.66}Ni_{0.1}Co_{0.1}Mn_{0.8}O₂:SE (the solid electrolyte NAC of Comparative Example O):super P=50:50:3 in a weight ratio was used instead of the composite prepared by mixing by mixing super P:SE (the solid electrolyte NAC of Comparative Example O)=2:8 in a weight ratio as the working electrode.

### Experimental Example

### Experimental Example 1: Structure Analysis XRD, NMR, and XPS

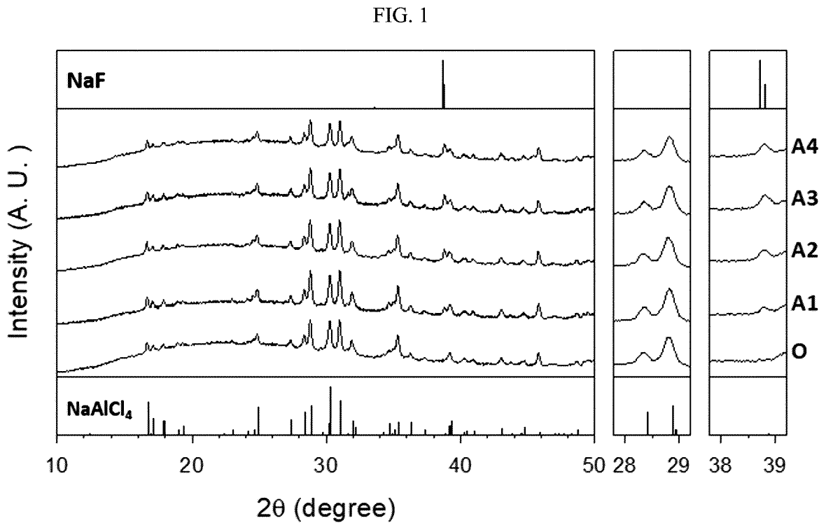

FIG. 1 shows the results of XRD analysis of the solid electrolytes of Examples A1 to A4 and Comparative Example O. XRD patterns were collected using a Rigaku MiniFlex600 diffractometer with Cu K_{α} radiation (λ=1.5406 Å). XRD cells including samples were mounted on an XRD diffractometer and measured at 40 kV and 15 mA.

According to this, an NaAlCl₄ peak was maintained as it was without peak shifting, but a NaF peak appeared. This means that F was not substituted in an orthorhombic lattice structure of NaAlCl₄, which confirmed that the solid electrolyte samples of Examples A1 to A4 included NaF and NaAlCl₄ as final products. Accordingly, a portion of an Na component of the initially introduced NaF was used as a precursor of NaAlCl₄, but the F component of NaF used as the precursor of NaAlCl₄ was confirmed to be used for forming other phases, which were not indicated by XRD.

In conclusion, in the solid electrolyte samples of Examples A1 to A4, F was not substituted into NaAlCl₄, but the solid electrolyte samples of Examples A1 to A4 were confirmed to be present as composites including NaAlCl₄ and NaF, etc.

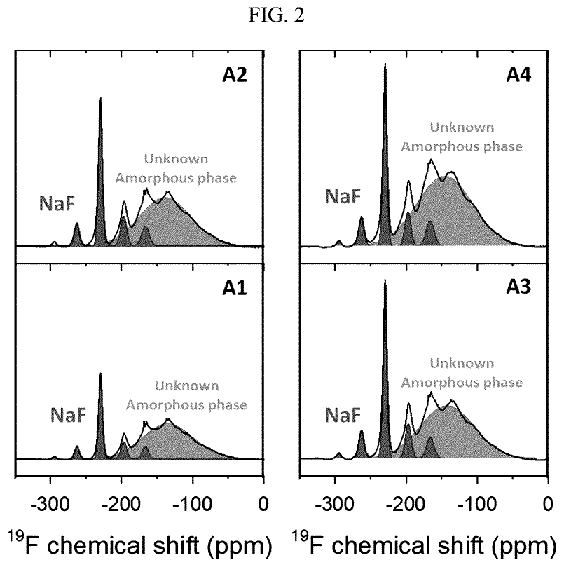

FIG. 2 shows the ¹⁹F MAS NMR (F magic angle spinning nuclear magnetic resonance) analysis results of the solid electrolytes of Examples A1 to A4 to confirm the presence of fluorine (F). Herein, the ¹⁹F MAS NMR analysis was performed by using 400 MHz Avance II, which is a 400 MHz (B) solid-phase NMR spectrometer (Solid state NMR Spectrometer) of the Korea Basic Science Institute (KBSI). According to this, a sodium fluoride (NaF) peak and an amorphous peak (amorphous peak) appeared.

In other words, in the ¹⁹F MAS NMR analysis, a broad peak formed over a range of −30 ppm to −250 ppm was present, and the peak turned out to be an amorphous peak due to an amorphous phase showing complex structural heterogeneity. Herein, the results were measured by using the Origin program and selecting a Gaussian function in the program to extract/separate the NaF peak and the amorphous peak from the ¹⁹F MAS NMR analysis result.

In addition, referring to FIG. 2, the amorphous peak was confirmed to be larger from Example A1 to Example A4. Therefore, it may be said that as a ratio of sodium fluoride (NaF) increased, an amount of the amorphous phase generally increased.

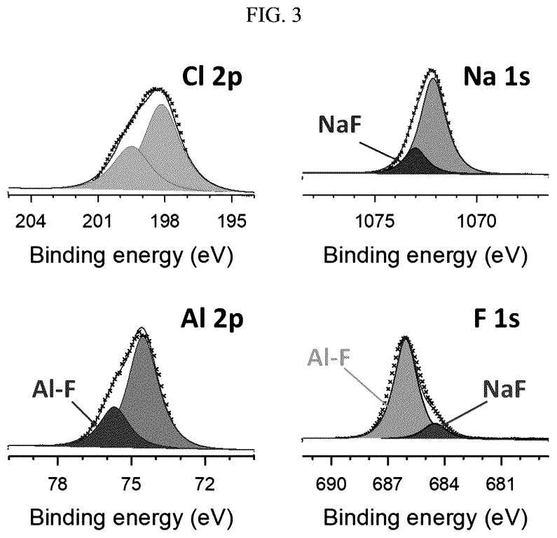

FIG. 3 shows the X-ray photoelectron spectroscopy (XPS) analysis result of the solid electrolyte prepared in Example A4. Herein, the XPS analysis was performed by using K-Alpha+ (Thermo Fisher Scientific) within a range of 12 kV and 6 mA with a monochromatic Al Kα source (1486.6 eV).

According to the XPS analysis result, a peak of NaAlCl₄ appeared, and additionally, an Al—F bond was confirmed at F1s and Al 2p XPS.

Therefore, considering that the solid electrolyte of Example A4 was prepared by a combination of NaF and AlCl₃ in a mole ratio of 1:1, the presence of the Al—F bond confirmed that the precursors were reacted with each other to form a multi-phase product including the amorphous phase. Accordingly, the amorphous peak confirmed in the NMR analysis was confirmed to contain the Al—F bond.

In addition, referring to the ¹⁹F MAS NMR analysis data for the NaF and the Al—F bond where F elements may exist, each of Examples A1 to A4 was measured with respect to a median value of the amorphous peak and a full width at half maximum (FWHM), and the results are shown in Table 1.

TABLE 1

| | Example A1 | Example A2 | Example A3 | Example A4 |
|---|---|---|---|---|
| Median | −134.96 | −138.73 | −142.30 | −145.63 |
| value (ppm) | | | | |
| FWHM (ppm) | 83.46 | 84.91 | 89.33 | 92.17 |

Referring to Table 1, in Examples A1 to A, the amorphous peak was confirmed to have a median value within a range of −130 ppm to −150 ppm and a full width at half maximum (FWHM) within a range of 80 ppm to 95 ppm.

On the other hand, the Al—F bond may be distinguished through the ¹⁹F MAS NMR analysis by bridging fluorine represented by Chemical Formula A and terminal fluorine represented by Chemical Formula B. However, it is known that as for fluorine (F) bonded to Al³⁺, the terminal fluorine had a peak median value within a range of −170 ppm to −220 ppm, but the bridging fluorine had a peak median value within a range of −130 ppm to −170 ppm.

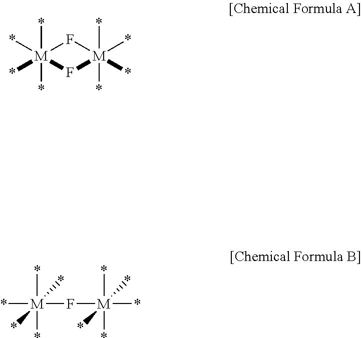

In Chemical Formula A or B,

The definition of M is the same as described above, and * indicates a position linked to another element.

Accordingly, because Examples A1 to A4 exhibited a median value of an amorphous peak within a range of −130 ppm to −150 ppm, the amorphous phase contained the Al—F bond, and this Al—F bond had a bridging fluorine structure represented by Chemical Formula A.

In addition, the reason that the composites for a solid electrolyte according to Examples A1 to A4 had high ionic conductivity, which is described later in Experimental Example 2 is believed to be due to a bridging fluorine structure in the above amorphous phase.

### Experimental Example 2: Measurement of Ionic Conductivity

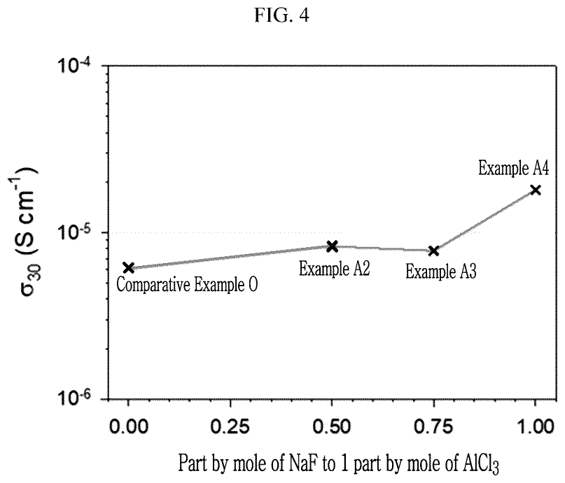

FIG. 4 shows the ionic conductivity measurement results for the solid electrolytes of Examples A2 to A4 and Comparative Example O. Sodium ionic conductivity was measured by using a sodium ion-blocked Ti/solid electrolyte/Ti symmetric cell in an AC method. Herein, the ionic conductivity in FIG. 4 was measured by using an impedance-measuring equipment (Manufacturer: Bio-Logic Inc., Model name: VMP3) within a frequency range of 10 mHz to 7 MHz at 30° C. under an Ar atmosphere.

According to this, from Example A2 to Example A4, that is, in general, as the amount of sodium fluoride (NaF) increased, Na ionic conductivity increased. As shown in the above NMR analysis results, from Example A2 to Example A4, that is, as the amount of sodium fluoride (NaF) increased, because a ratio of the amorphous phase (or, an amount of the amorphous phase) in general increases, the amorphous phase may be expected to increase ionic conductivity of Na.

In order to find a sample with the highest ionic conductivity in the examples according to an embodiment, 12 example samples of the and 1 comparative example sample were all measured with respect to ionic conductivity, and the results are shown in Table 2. Herein, in Table 2, the ionic conductivity was measured by using an impedance-measuring equipment (Manufacturer: Bio-Logic, Model name: VMP3) within a frequency range of 10 mHz to 7 MHz at 30° C. under an Ar atmosphere.

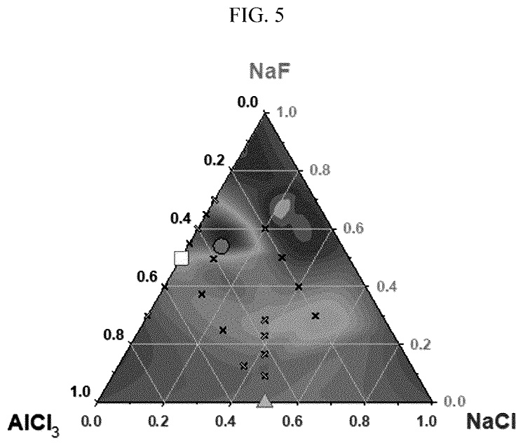

In addition, the ionic conductivity results are shown as a contour map in FIG. 5. According to this, in the contour map, a triangle mark (Δ) indicates the NaAlCl₄ solid electrolyte of Comparative Example O, a quadrangle mark (□) indicates the NACF solid electrolyte of Example A4, and a circle mark (○) indicates the NACF solid electrolyte with the highest conductivity of Example D2.

TABLE 2

| | | | | Ionic |
|---|---|---|---|---|
| | | | | conductivity at |
| | NaCl | NaF | AlCl₃ | 30° C. (Scm⁻¹) |
| Comparative | 0.5 | 0 | 0.5 | 6.18 x 10⁻⁶ |
| Example O (═NAC) | | | | |
| Example A2 | 0.25 | 0.25 | 0.5 | 8.30 × 10⁻⁶ |
| Example A3 | 0.125 | 0.375 | 0.5 | 7.80 × 10⁻⁶ |
| Example A4 | 0 | 0.5 | 0.5 | 1.81 × 10⁻⁵ |
| Example B3 | 0.3846 | 0.2308 | 0.3846 | 1.12 × 10⁻⁵ |
| Example B4 | 0.3571 | 0.2857 | 0.3571 | 1.12 × 10⁻⁵ |
| Example C1 | 0 | 0.6 | 0.4 | 2.08 × 10⁻⁵ |
| Example C2 | 0 | 0.7 | 0.3 | 1.08 × 10⁻⁵ |
| Example D1 | 0.1 | 0.495 | 0.405 | 1.45 × 10⁻⁵ |
| Example D2 (NACF Max) | 0.1 | 0.54 | 0.36 | 3.08 × 10⁻⁵ |
| Example D3 | 0 | 0.65 | 0.35 | 2.13 × 10⁻⁵ |
| Example D4 | 0 | 0.55 | 0.45 | 2.36 × 10⁻⁵ |
| Example D5 | 0.5 | 0.3 | 0.2 | 1.47 × 10⁻⁵ |

Referring to Table 2, compared to the NaAlCl₄ solid electrolyte of Comparative Example O, the solid electrolytes of the examples were confirmed to exhibit excellent ionic conductivity at 30° C.

In particular, the solid electrolyte of Example A4, compared to the NaAlCl₄ (NAC) solid electrolyte of Comparative Example O, exhibited twice or more higher ionic conductivity at 30° C. In addition, the solid electrolyte of Example A4, compared to Examples A2 and A3 having the same AlCl₃ addition amount as Example A4, exhibited significantly improved ionic conductivity.

In addition, as a research result for maximizing the ionic conductivity-improving effect, the solid electrolyte of Example D2, compared to the other examples, exhibited the most excellent ionic conductivity improving effect.

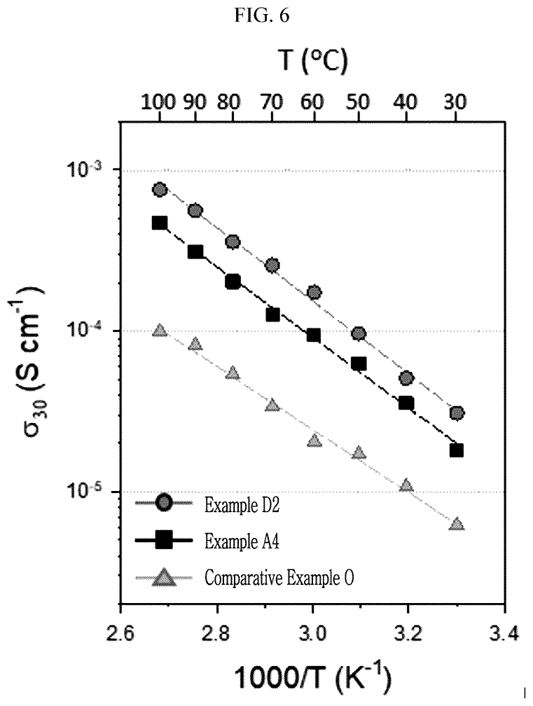

In addition, FIG. 6 shows Arrhenius plots of the NaAlCl₄ solid electrolyte of Comparative Example O (triangle (Δ) of FIG. 6), the NACF solid electrolyte of Example A4 (quadrangle (□) of FIG. 6), and the NACF solid electrolyte of Example D2 (circle (○) of FIG. 6), which are characteristic samples. Herein, the ionic conductivity of FIG. 6 was measured by using an impedance-measuring equipment (Manufacturer: Bio-Logic, Model name: VMP3) within a frequency range of 10 mHz to 7 MHz at 30° C. to 100° C. under an Ar atmosphere.

According to FIG. 6, compared to the NaAlCl₄ solid electrolyte of

Comparative Example O, the NACF solid electrolytes of Examples A4 and D2 exhibited higher ionic conductivity. In particular, the NACF solid electrolyte of Example D2, compared to the NACF solid electrolyte of Example A4, exhibited more excellent ionic conductivity.

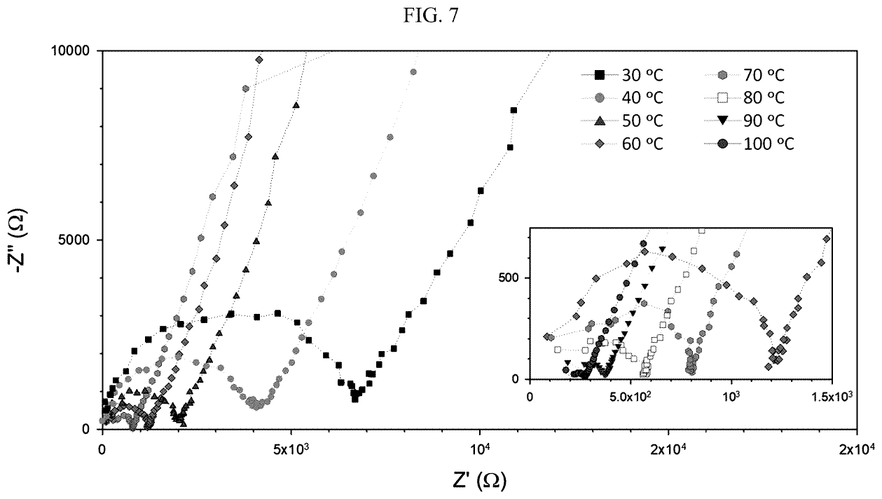

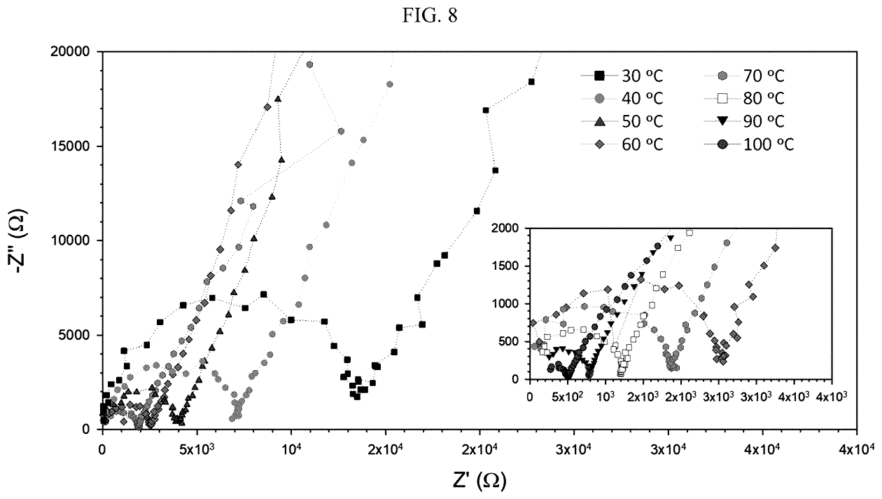

On the other hand, FIGS. 7 and 8 show Nyquist plots of a sodium ion-blocked Ti/solid electrolyte/Ti symmetric cell in which sodium ions were blocked for each of the solid electrolyte samples of Examples D2 and A4 at different temperature. Herein, in FIGS. 7 and 8, the ionic conductivity was measured by using an impedance-measuring equipment (Manufacturer: Bio-Logic, Model name: VMP3) within a frequency range of 10 mHz-7 MHz at 30° C. to 100° C. under an Ar atmosphere.

Comparing FIG. 7 with FIG. 8, compared to when the solid electrolyte of Example A4 was used, when the solid electrolyte of Example D2 was used, each resistance at the same temperature was lower.

### Experimental Example 3: Cyclic Voltammetry (CV) Measurement

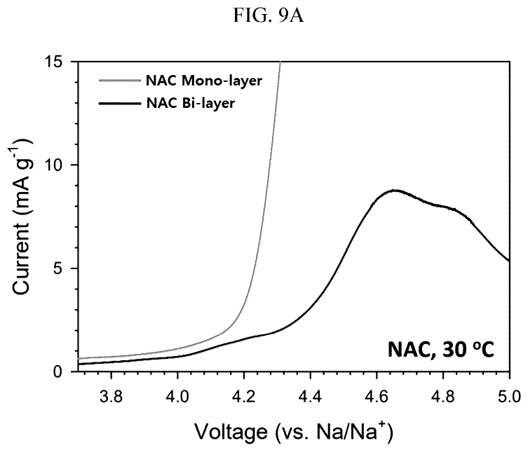

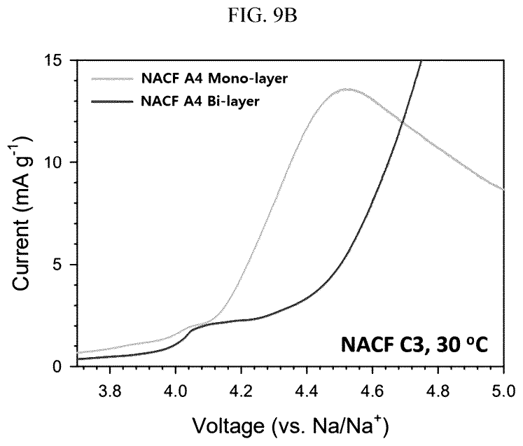

FIG. 9A and FIG. 9B show the first cyclic voltammetry measurement results for the CV cells of Device Example 1 (NACF A4 Bi-layer), Device Example 2 (NACF A4 Mono-layer), Device Comparative Example 1 (NAC Bi-layer) and Device Comparative Example 2 (NAC Mono-layer) at 0.1 mV/s and at 30° C.

According to this, the CV cell of Device Example 1 (NACF A4 Bi-layer), compared to that of Device Example 2 (NACF A4 Mono-layer), exhibited much higher onset potential (onset potential), and the CV cell of Device Comparative Example 1 (NAC Bi-layer), compared to that of Device Comparative Example 2 (NAC Mono-layer), exhibited much higher onset potential (onset potential).

In other words, in both the solid electrolyte (NAC) of Comparative Example O and the solid electrolyte (NACF) of Example A4, cells having a single solid electrolyte layer exhibited a lower onset potential than cells having a dual solid electrolyte layer.

Two cells respectively having the single solid electrolyte layer and the dual solid electrolyte layer used a working electrode (W.E.) of the same material in the same amount, but there was a difference in which electrolyte the working electrode was in contact with.

Accordingly, the reason that the single solid electrolyte layer cell in contact with an NPS (Na₃PS₄) electrolyte exhibited a lower onset potential was why a side reaction with the NPS (NasPS4) electrolyte first occurred, while increasing a voltage, and then, a decomposition reaction of the solid electrolyte (NAC) of Comparative Example O or the solid electrolyte (NACF) of Example A4 in the working electrode occurred.

In addition, based on a smaller difference of the NACF mono-layer/bi-layer cell exhibited than that of the NAC mono-layer/bi-layer cell, the solid electrolyte (NACF) of Example A4 was confirmed to have a relatively lower side reaction with the NPS (Na₃PS₄) electrolyte than the solid electrolyte (NAC) of Comparative Example O.

In addition, each of the cells of the Device Examples 1 and 2 and Device Comparative Example 2 was measured with respect to a CV integrated oxidation current, and the results are shown in Table 3.

TABLE 3

| | | CV integrated oxidation current value (mA V g⁻¹) | | |
|---|---|---|---|---|
| | Upper | Device | Device | Device |
| | cut-off | Comparative | Example 2 | Example 1 |
| | voltage | Example 2 | (NACF A4 | (NACF A4 |
| Temperature | (V) | (NAC Mono-layer) | Mono-layer) | Bi-layer) |
| 30° C. | 4.2 | 0.8 | 1.0 | 0.7 |
| 30° C. | 5 | 44.6 | 9.6 | 9.9 |
| 60° C. | 4.2 | 62.9 | 25.7 | 2.8 |
| 60° C. | 5 | 51.5 | 51.4 | 29.8 |

Referring to Table 3, the CV integrated oxidation current value of the CV cell of Device Example 2 (NACF A4 Mono-layer) was significantly lower than that of the CV cell of Device Comparative Example 2 (NAC Mono-layer). This result shows that the solid electrolyte (NACF) of Example A4 exhibited better durability in terms of side reactions to NPS than the solid electrolyte (NAC) of Comparative Example O.

Referring to the above results, the solid electrolyte (NAC) of Comparative Example O with NPS generated a severe interface degradation, particularly, in high voltage and/or high temperature environments. On the other hand, the solid electrolyte (NACF) of Example A4 had a smaller side reaction with NPS. Finally, the solid electrolyte (NACF) of Example A4, compared to the solid electrolyte (NAC) of Comparative Example O, exhibited excellent compatibility with NPS.

In addition, the CV cell of Device Example 1 (NACF A4 Bi-layer), compared to the CV cell of Device Example 2 (NACF A4 Mono-layer), exhibited a lower CV integrated oxidation current value. This is believed that as for the dual solid electrolyte layer, the interface side reaction between NPS and NACF was significantly limited by blocking electronic conduction on the interface.

In conclusion, the solid electrolyte (NACF) of Example A4 exhibited excellent compatibility with NPS, compared to the solid electrolyte (NAC) of Comparative Example O. In addition, the cell using the solid electrolyte (NACF) of Example A4 and simultaneously, having the dual solid electrolyte layer was confirmed to effectively prevent interface deterioration.

### Experimental Example 4: Voltage Step Half-Cell Test

In order to check an extent of the influence of the side reaction of Experimental Example 3, each of the half-cells of Device Example 3 (NACF A4 Bi-layer), Device Example 4 (NACF A4 Mono-layer), Device Comparative Example 3 (NAC Bi-layer), and Device Comparative Example 4 (NAC Mono-layer) was subjected to a voltage step half-cell test of at 30° C., while increasing a cut-off voltage.

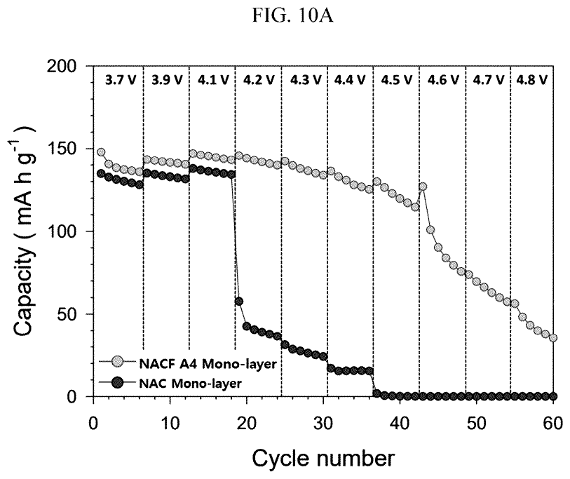

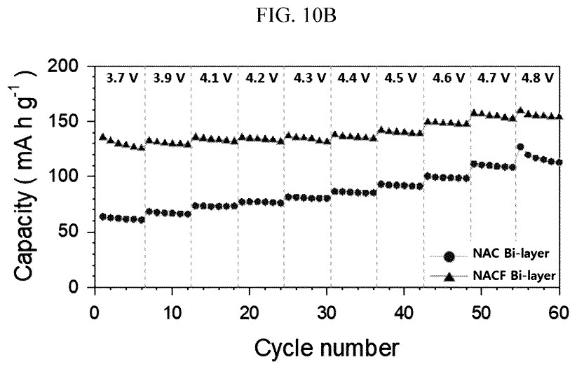

FIG. 10A and FIG. 10B show the voltage step half-cell test results. Herein, a lower cut-off voltage was fixed at 1.5 V (vs. Na/Na⁺), and an upper cut-off voltage was gradually increased to 4.8 V by 0.2 V or 0.1 V.

According to FIG. 10A, which shows the result of the half-cell of Device Example 4 (NACF A4 Mono-layer) and Comparative Device Example 4 (NAC Mono-layer), the half-cell of Comparative Device Example 4 (NAC Mono-layer) was damaged by severe side reactions at 4.2 V, but the half-cell of Device Example 4 (NACF Mono-layer) was damaged after maintaining capacity up to 4.4 to 4.5 V.

Such gradual damages on the half-cell of Device Example 4 (NACF A4 Mono-layer) were thought to come from decomposition of catholyte and slow formation of interfacial reaction. Because the solid electrolyte (NACF) of Example A4 used in the half-cell of Device Example 4 (NACF A4 Mono-layer) was a composite including NaAlCl₄, it is estimated that a side reaction was inevitable to some degrees on the inter face of NACF and NPS due to a structure of the single solid electrolyte layer. However, the solid electrolyte (NACF) of Example A4 exhibited a slight degree of side reactions for NPS, compared to the solid electrolyte (NAC) of Comparative Example O, which was confirmed by contrasting the results between the half-cells of Device Example 4 (NACF A4 Mono-layer) and Device Comparative Example 4 (NAC Mono-layer) in FIG. 10A. Through these results, the half-cell of Device Example 4 (NACF Mono-layer) was confirmed to withstand to a slightly higher voltage in the side reaction with NPS.

On the other hand, comparing the results of the half-cell of Device Comparative Example 4 (NAC Mono-layer) in FIG. 10A and the half-cell of Device Comparative Example 3 (NAC Bi-layer) in FIG. 10B, the half-cell of Device Comparative Example 3 (NAC Bi-layer), compared to that of Device Comparative Example 4 (NAC Mono-layer), was more stably performed to 4.8 V at most. This shows that the interface side reaction between NAC and NPS had greater effects on capacity reduction at a high voltage of greater than or equal to 4.2 V than the oxidation decomposition of NAC. Within a stable redox voltage range of 3.7 V to 4.1 V, where the capacity reduction was not critical, the half-cell of Device Comparative Example 3 (NAC Bi-layer) exhibited lower capacity than that of Device Comparative Example 4 (NAC Mono-layer). The reason may be caused from an increase in resistance of a separator including a dual solid electrolyte layer in the half-cell of Device Comparative Example 3 (NAC Bi-layer), which is supported by Experimental Example 6 to be described later.

In addition, in FIG. 10B, referring to the results of the half-cell of Device Example 3 (NACF A4 Bi-layer), an NACF Bi-layer half-cell was confirmed to be charged and discharged without rapid damages to a cut-off voltage of 4.8 V.

Accordingly, compared to the case of introducing a single solid electrolyte layer such as Device Example 4 (NACF A4 Mono-layer) or Device Comparative Example 4 (NAC Mono-layer), the case of introducing a dual solid electrolyte layer such as Device Example 3 (NACF A4 Bi-layer) or Device Comparative Example 3 (NAC Bi-layer) may escape serious resistance evolution on the interface. In other words, Device Example 3 (NACF A4 Bi-layer) and Device Comparative Example 3 (NAC Bi-layer) exhibited stable cycling characteristics to a maximum of 4.7 V. This was a higher voltage than the initiation potential of the catholyte decomposition, which was confirmed in Device Example 1 (NACF A4 Bi-layer) and Device Comparative Example 1 (NAC Bi-layer) in FIG. 9A and FIG. 9B of Experimental Example 3. This proves that the increase in resistance due to the interface reaction between Na halide and NPS was much larger than resistance due to the catholyte decomposition. Accordingly, a three-phase boundary including halide, NPS, and an electron conductive material (carbon or NaNCM, etc.) may be avoided by the introduction of the dual solid electrolyte layer. The dual solid electrolyte layer including halide is assumed to impede continuous resistance evolution, and whether or not electrons are supplied onto the interface between sulfide and halide solid electrolyte is assumed to play an important role of expanding the interface reaction.

In addition, in FIG. 10B, comparing the results of the half-cells of Device Example 3 (NACF A4 Bi-layer) and Device Comparative Example 3 (NAC Bi-layer), the half-cell of Device Example 3 (NACF A4 Bi-layer), compared to that of Device Comparative Example 3 (NAC Bi-layer), exhibited excellent capacity characteristics.

This result shows that the introduction of the NACF A4 solid electrolyte into the sodium all-solid-state battery cell significantly alleviated the interface side reaction with NPS. In addition, it was confirmed that damages on the cell having the NAC solid electrolyte at a high voltage were mainly caused by the side reaction between NAC and NPS, which was solved by introducing a bilayer including NACF.

### Experimental Example 5: Measurement of Side Reactions between NaAlCl₄ (NAC) and Na₃PS₄ (NPS) Depending on Temperature

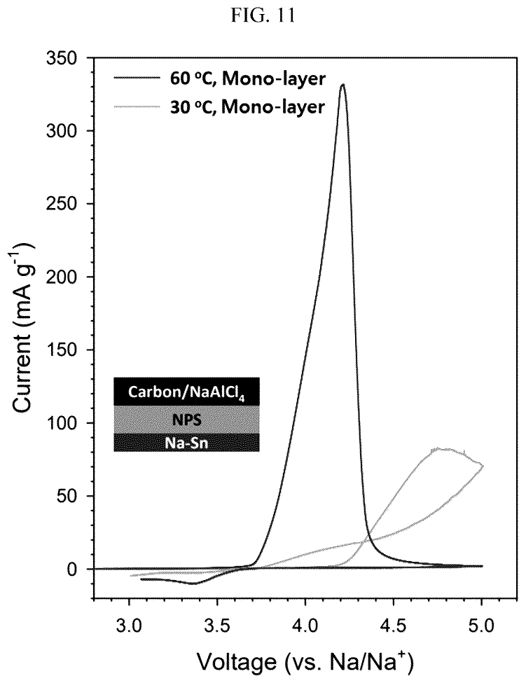

FIG. 11 shows the effect of a temperature on the NAC-NPS side reaction, which was measured through data of the CV cell of Device Comparative Example 2 (NAC Mono-layer) at 30° C. and 60° C.

At 30° C., an onset voltage (onset potential) of the NAC Mono-layer CV cell started at 4.1 V or so, but at 60° C., the onset voltage (onset potential) of the NAC Mono-layer CV cell started at 3.8 V or so, and accordingly, the CV cell of Device Comparative Example 2 had a low onset voltage and a high current peak. This result confirms that an NPS-NAC side reaction may more easily and more occur at high temperature at a lower voltage. Accordingly, the interface reaction between NPS and NAC was confirmed to be more severe in a high-temperature environment such as 60° C.

In addition, referring to the experiment results of the Table 3, an amount of an integrated oxidation current value at 60° C. was twice or more as high as that at 30° C. in all CV cells.

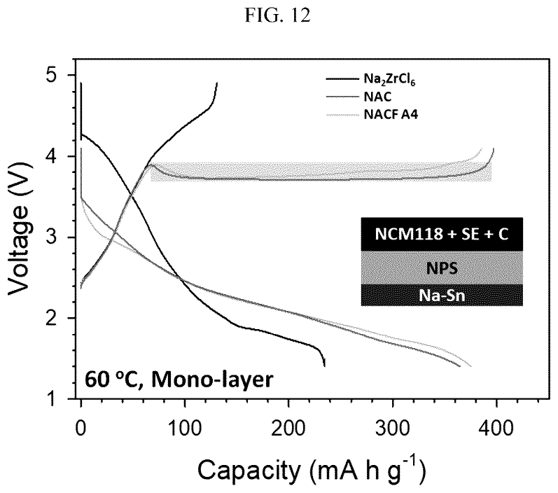

In addition, FIG. 12 shows charge and discharge curves of the mono-layer half-cells respectively including Device Example 4 (NACF A4 Mono-layer), Device Comparative Example 4 (NAC Mono-layer), and an Na₂ZrCl₆ electrolyte at 60° C. According to this, the cell including Na₂ZrCl₆ in which Na₂ZrCl₆ had no side reaction with NPS exhibited a general voltage profile of Na_{0.66}Ni_{0.1}Co_{0.1}Mn_{0.8}O₂, but the cells respectively containing NAC and NACF single solid electrolyte layers exhibited a plateau phenomenon not occurring in an active material after 3.8 V at a high temperature of 60° C. Accordingly, Device Example 4 (NACF A4 Mono-layer) and Device Comparative Example 4 (NAC Mono-layer) exhibited charge profiles delayed around 3.7 V to 3.8 V, which are presumed to be caused from an interface reaction between NPS and NAC (or NPS and NACF).

Subsequently, because a significant overpotential was observed in the following discharge profiles but kinetically stabilized at 30° C., an interface reaction occurred between NPS and NAC at 4.2 V or more but at 60° C., was more activated and occurred around 3.7 V.

This result confirmed that cells containing NAC and NACF single solid electrolyte layers had a severe side reaction with NPS in high-temperature environments and were difficult to normally charge and discharge.

### Experimental Example 6: Impedance Analysis

In order to examine resistance changes before and after the interface side reaction within four different types of cells, an electrochemical impedance spectroscopy (EIS) experiment was performed. The EIS experiment was performed in CV cells to eliminate influences of resistance evolution on the CAM-catholyte interface.

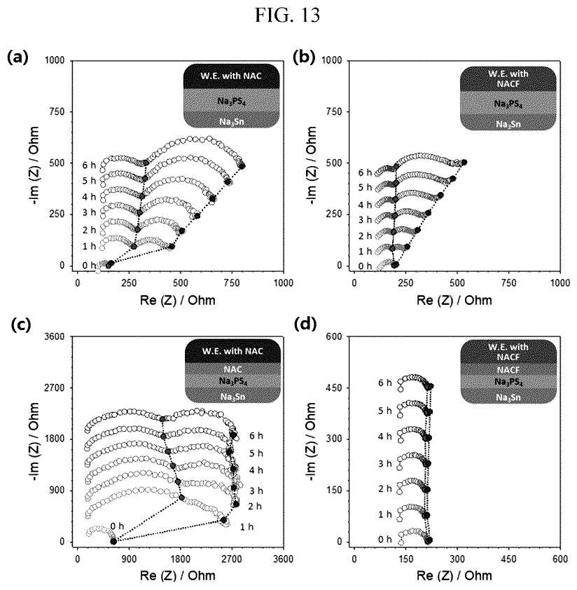

FIG. 13 shows the experimental results of applying a voltage to the CV cells of Device Comparative Example 2 (NAC Mono-layer) (a), Device Example 2 (NACF A4 Mono-layer) (b), Device Comparative Example 1 (NAC Bi-layer) (c), and Device Example 1 (NACF A4 Bi-layer) (d) to measure the impedance.

An experiment method was to initially collect impedance data in the original state and then, measure impedance in each CV cell after equilibrating a temperature of the cells at 60° C. The impedance data of FIG. 13 were obtained by applying 4.2 V for 1 hour at the same temperature and then, 6 times repeatedly measuring impedance under the same conditions. The experiment conditions of 4.2 V and 60° C. were selected to allow an interface reaction based on the results shown in FIGS. 9 and 10.

In all four setting of (a) to (d) of FIG. 13, the impedance data in the original state exhibit only one semicircle representing resistance of a separator including resistance from a dual solid electrolyte layer.

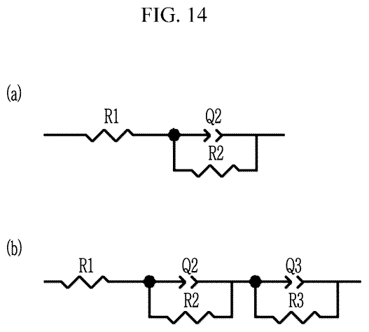

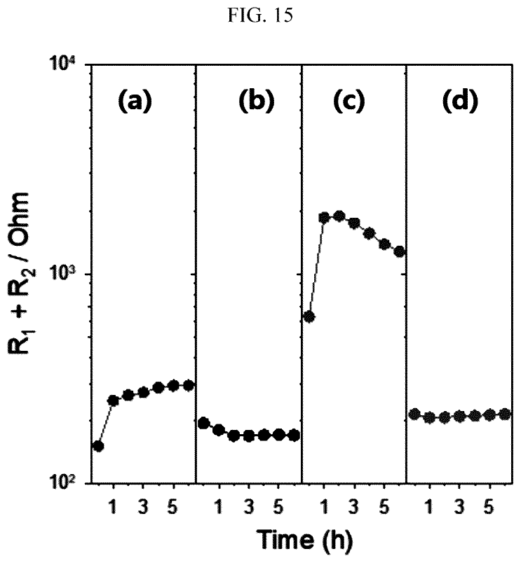

The impedance data in the original state was fitted by using an equivalent circuit model of FIG. 14(a), and capacitance values exactly matched with values of grains and grain boundaries of the separator. In the cell settings (a), (b), and (d) of FIG. 13, each separator had a resistance range of 150 Ω to 200 Ω, which is related to ionic conductivity of NPS (and NACF Bi-layer) at 60° C. On the contrary, the cell setting (c) of FIG. 13 exhibited much higher resistance of 626 Ω. This result, as shown in FIG. 15, also was consistent with lower discharge capacity of the cell setting (c) of FIG. 13 than those of the cell settings (a), (b), and (d) of FIG. 13.

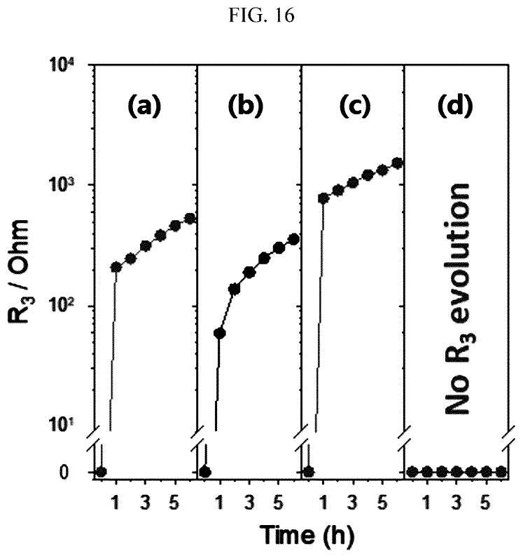

When a voltage of 4.2 V was applied within a frequency range of 55000 Hz to 10 Hz, a new resistance component appeared in the cell settings (a) to (c) of FIG. 13. The resistance observed in the original state was indicated as R₁+R₂ (R₁: bulk resistance, R₂: grain resistance), and resistance newly generated after applying 4.2 V in the low frequency region was indicated as R₃. The impedance data after applying 4.2 V was fitted by using an equivalent circuit model of FIG. 14(b). Subsequently, capacitance of Q₃ related to R₃ was in a range of 10⁻⁵ to 10⁻⁶ F. As a result, a newly formed semicircle indicated as R₃ was concluded to be related to interface degradation between NPS and NAC. In other words, R₁+R₂ indicates resistance of each of the separators, and R₃ indicates the interface resistance formed by interface degradation of sulfide and halide after applying a high voltage. The results of the fitted data are shown in FIGS. 15 and 16.

In (a) and (b) of FIG. 13, when 4.2 V was applied, the cell of FIG. 13(a) exhibited a continuous increase of R₁+R₂, and the cell of FIG. 13(b) exhibited no increase of R₁+R₂. In addition, R₃ increased more in the cell of FIG. 13(a) than in that of FIG. 13(b). The result implied that NACF was less deteriorated than NAC and also, was consistent with that of FIG. 10A.

In (c) of FIG. 13, the (NAC Bi-layer) CV cell of Device Comparative Example 1 was not sufficient to prevent the interface degradation. When a voltage was applied, a total resistance (R₁+R₂+R₃) was confirmed to increase from 626.3 Ω to about 2700 Ω after 1 hour to be saturated. After applying the voltage for 1 hour, in the Nyquist plot, a semicircle is not clearly found, but as time goes, there must be two semicircles containing R₁+R₂ and R₃. This means that there was a side reaction between NAC and NPS even on the binary interfaces having no electron conductive material. This implies that when a combination of components occurs, interface deterioration also actively occurs even in a bilayer configuration.

Lastly, in (d) of FIG. 13, there was no evolution of R₃ and no increase of R₁+R₂. This exhibited that the bilayer configuration using NACF was effectively blocked from the interface deterioration even at 60° C. and 4.2 V. This observation was further supported by the result that the CV cell of Device Example 1 (NACF A4 Bi-layer) according to FIG. 13(d) exhibited excellent performance among four different types of cells of FIG. 13(d), FIG. 15, and FIG. 16.

### Experimental Example 7: Cycle Characteristic Analysis

Long-term cycling performance of NACF as a catalyst for 4 V class Na_{0.66}Ni_{0.1}Co_{0.1}Mn_{0.8}O₂/Na₃Sn ASNB was evaluated and compared to that of NAC at 30° C. and 60° C. In order to eliminate the effect of an interface side reaction between NPS and NAC, the bilayer configuration was used in both of the cells.

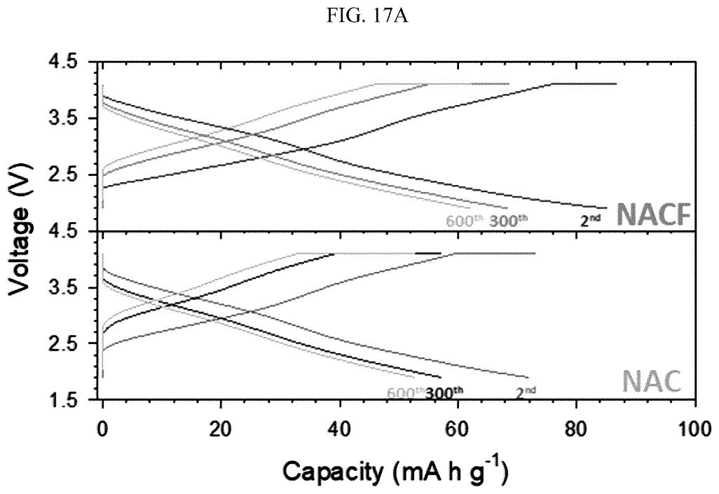

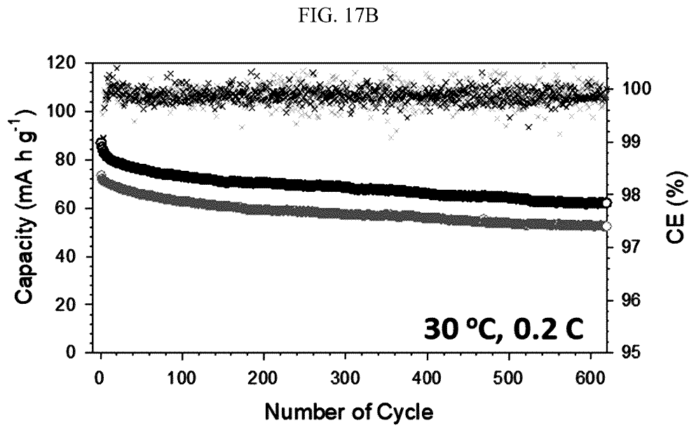

Specifically, FIG. 17A and FIG. 17B exhibit cycle performance and voltage profiles analysis results of the half-cells at the corresponding voltages under the conditions of 30° C. and 0.2 C. Herein, a charging process was performed in a CCCV mode limited to current density of 0.02 C.

The upper portion of FIG. 17A and the dark color of FIG. 17B show the results of the half-cell of Device Example 3 (NACF A4 Bi-layer), and the lower portion of FIG. 17A and the light color of FIG. 17B show the results of the half-cell of Device Comparative Example 3 (NAC Bi-layer). In addition, in FIG. 17B, dots represent discharge capacity, and lines represent coulombic efficiency (CE). According to this, because of high ionic conductivity of catholyte at the first cycle, discharge capacity of NACF was 87.0 mA h g⁻¹, which was a little higher than 73.5 mA h g⁻¹ of that of NAC. In addition, NAC exhibited capacity retention of 71.7% to the 600-th cycle, and NACF exhibited capacity retention of 71.5%, which were almost the same. As for average coulombic efficiency from the 2^{nd} cycle to the 600-th cycle, NAC exhibited 100.0%, while NACF exhibited 99.9%, which were similar each other.

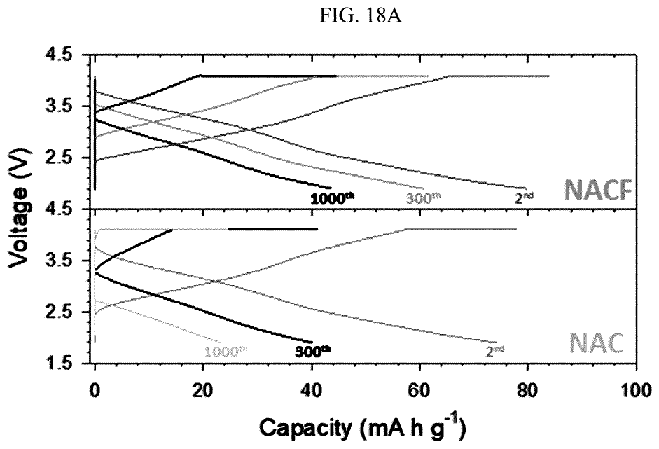

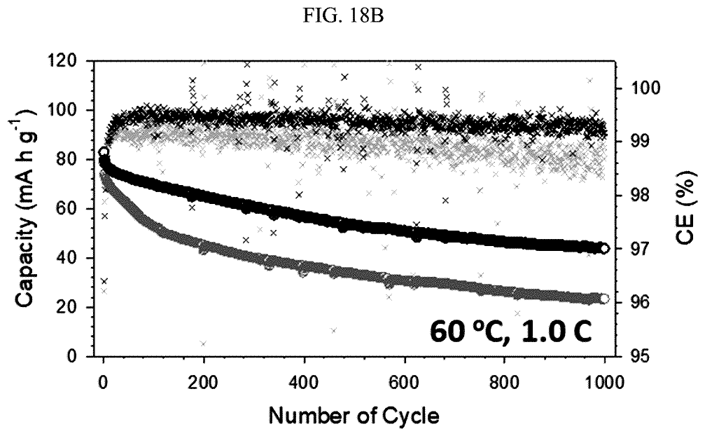

In addition, FIG. 18A and FIG. 18B show cycle characteristic analysis results of the half-cells under the conditions of 60° C. and 1.0 C. Herein, the upper portion of FIG. 18A and the dark color of FIG. 18B show the result of the half-cell of Device Example 3 (NACF A4 Bi-layer). The lower portion of FIG. 18A and the light color of FIG. 18B show the results of the half-cell of Device Comparative Example 3 (NAC Bi-layer). In addition, in FIG. 18B, dots represent discharge capacity, and lines represent coulombic efficiency (CE).

According to this, as shown in FIG. 18A and FIG. 18B, the results of FIG. 17A and FIG. 17B at 60° C. were significantly different from those of FIG. 17A and 17B at 30° C., and NACF exhibited much better capacity retention than NAC. At the first cycle, NAC and NACF respectively exhibited discharge capacity of 78.6 mA h g⁻¹ and 83.1 mA h g⁻¹. The NAC cell exhibited sharp capacity reduction for the first 200 cycles, during which the capacity was reduced almost to a half. On the contrary, the NACF cell maintained 64.3% of discharge capacity from the first cycle to the 500-th cycle and 52.8% of discharge capacity at the 1000-th cycle, which exhibited relatively slow capacity reduction.

On the other hand, two cells all exhibited lower capacity retention at 60° C. than at 30° C. As average coulombic efficiency also increased, as a temperature increased, wherein NAC exhibited a decrease to 98.9%, and NACF exhibited a decrease to 99.4%. This may be typical when an upper cut-off voltage of a cell is higher than an oxidation limit of catholyte. The interface between kinetically passivated CAM and catholyte at 30° C. slowly deteriorated at 60° C. This indirectly shows that oxidation stability of NACF was more excellent that that of NAC.

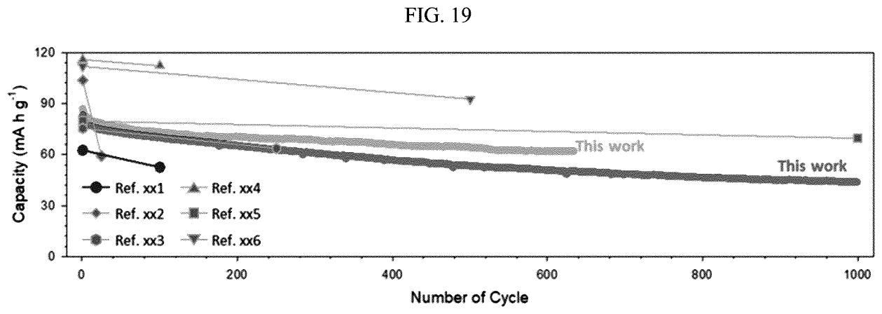

Finally, the cell performance of NACF was evaluated by comparing it with that of the state-of-the-art ASNB employing a 3 V or 4 V class layered oxide Na cathode, and the results are shown in FIG. 19 and Tables 4 and 5. On the other hand, in FIG. 19, Ref. xx2 to xx7 are marked, and 4 V class Na[Ni/Co/Mn/Fe]O₂ was indicated as Ref. xx1 and This work. Herein, the light and dark portions of This work of FIG. 19 respectively correspond to half-cell performances at 30° C. and 60° C.

TABLE 4

| | | | Voltage |
|---|---|---|---|
| | | | range |
| No. | SE material | CAM | (vs. Na/Na⁺) |
| 1 | NACF | Na_{0.66}Ni_{0.1}Co_{0.1}Mn_{0.8}O₂ | 2.0-4.2 V |
| 2 | Na₃B₂₄H₂₃-5Na₂B₁₂H₁₂ | Na[Ni_{1/3}Fe_{1/3}Mn_{1/3}]O₂ | 2.0-4.2 V |
| 3 | Na₃SbS₄ | NaCrO₂ | 1.2-3.7 V |
| 4 | Na₄(B₁₀H₁₀, B₁₂H₁₂) | NaCrO₂ | 2.0-3.25 V |
| 5 | Na₂ZrCl₆ | NaCrO₂ | 2.1-3.5 V |
| 6 | Na_{2.25}Y_{0.25}Zr_{0.75}Cl₆ | NaCrO₂ | 1.7-3.4 V |
| 7 | NaAlCl₄ | NaCrO₂ | 2.0-3.5 V |

TABLE 5

| | First cycle | Capacity | | | | |
|---|---|---|---|---|---|---|
| | discharge | retention | | C- | Temper- | |
| | capacity | rate | Cycle | rate | ature | |
| No. | (mA h g⁻¹) | (%) | number | (C) | (° C.) | Ref. |
| 1 | 86.97 | 71.5 | 600 | 0.2 | 30 | Device |
| | 83.07 | 52.8 | 1000 | 1 | 60 | Example 3 |
| 2 | 51.32 | 86.5 | 50 | 0.1 | 25 | Ref. xx1 |
| | 62.51 | 84.1 | 100 | 0.1 | 60 | |
| 3 | 103.7 | 57.1 | 25 | 0.1 | 30 | Ref. xx2 |
| 4 | 75.34 | 84.4 | 250 | 0.2 | 30 | Ref. xx3 |
| 5 | 115.82 | 96.9 | 100 | 0.1 | 30 | Ref. xx4 |
| 6 | 79.72 | 88.3 | 1000 | 1 | 40 | Ref. xx5 |
| 7 | 113.97 | 82 | 300 | 0.2 | 30 | Ref. xx6 |
| | 111.82 | 82.9 | 500 | 1 | 60 | |

Ref. xx1: Chemical Engineering Journal 455 2023 140904
Ref. xx2: Angew. Chem. Int. Ed. 2016, 128, 9786-9790.
Ref. xx3: Energy & Environmental Science 2017, 10 12, 2609-2615.
Ref. xx4: Energy Storage Mater. 2020, 26, 543-549.
Ref. xx 5: Nat. Commun. 2021, 12, 1256.
Ref. xx 6: ACS Energy Lett. 2022, 7, 3293.

Referring Tables 4 and 5, when NACF was used, the capacity retention rate was excellent during long-term cycling at an upper cut-off voltage of 4.2 V (vs. Na/Na⁺).

### Experimental Example 8: Measurement of Ratio of Amorphous Phase

Each of the composites for a solid electrolyte according to Examples A1 to A4 was subjected to a quantitative analysis of multi-phases including NaAlCl₄, NaF, and amorphous phases by measuring each ratio of NaAlCl₄, NaF, and amorphous phases as wt %, and the results are shown in Table 6. Herein, the quantitative analysis was performed in a Rietveld method of XRD data.

TABLE 6

| NaAlCl₄ (wt %) | NaF(wt %) | Material of amorphous phase (wt %) | |
|---|---|---|---|
| Example A1 | 27.2 | 3.4 | 69.3 |
| Example A2 | 9.7 | 7.8 | 82.5 |
| Example A3 | 10.8 | 5.3 | 83.9 |
| Example A4 | 18.7 | 4.4 | 76.9 |

Referring to Table 6, the composite for a solid electrolyte for a sodium all-solid-state battery obtained from Examples A1 to A4 included about 10 parts by mole to about 150 parts by mole of sodium fluoride (NaF) based on 100 parts by mole of sodium metal tetrachloride (NaMCl₄).

In addition, each of the composites for a solid electrolyte for a sodium all-solid-state battery according to Examples A1 to A4 was confirmed to include 50 wt % to 90 wt % of amorphous phase based on a total weight of the composite.

### Experimental Example 9: Analysis of Amorphous Phase

In order to analyze a shape of the amorphous phase in each of the composites for solid electrolytes according to Examples A1 to A4, a comprehensive evaluation was performed by using Raman spectroscopy along with the ¹⁹F MAS NMR results of Experimental Example 1. Accordingly, the amorphous phase was confirmed to be designated as a polyvalent anion-type of a composite Al(Cl, F)n, and fluorine (F), bridging fluorine in the amorphous phase, was confirmed to be bonded within the Al(Cl, F)n.

On the other hand, it is known that fluorine having a median peak within a range of −135 ppm to −146 ppm may be classified as corner covalent bridging fluorine having a coordination number (CN) of 5 or 6 and edge covalent bridging fluorine a coordination number (CN) of 5.

Accordingly, considering that each of the composites for a solid electrolyte of Examples A1 to A4 had an amorphous peak originating from the amorphous phase with a median value ranging from −135 ppm to −146 ppm, which was measured in Experimental Example 1 and the Raman spectroscopy results, possibility that the composites was Al(Cl, F)₄ may not be ruled out.

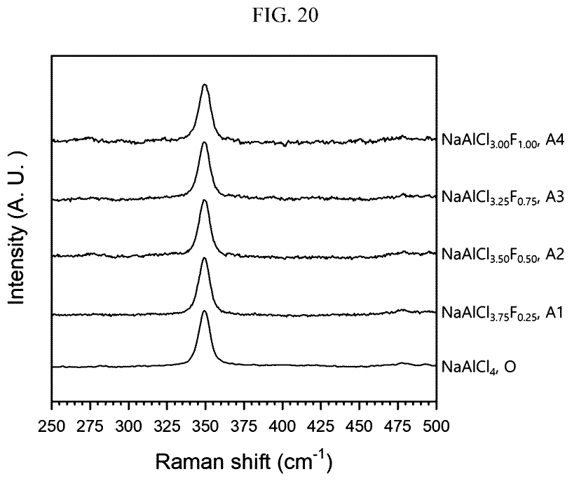

In addition, FIG. 20 shows the Raman spectroscopy results of the solid electrolytes of Examples A1 to A4 and Comparative Example O in the Raman analysis.

In the Raman analysis results, only vibrations of AlCl₄⁻ rather than vibrations of AlCl₄₋ₘFm⁻ (m=1, 2, 3, and or 4) were detected.

In conclusion, the composites for a solid electrolyte according to Examples A1 to A4 mainly had a NaAlCl₄ or AlCl₄⁻ unit and an amorphous phase, but in the case of fluorination, 5⁻ or 6⁻ coordinated Al(Cl, F)n units along with bridging fluorine were generated.

The composites for a solid electrolyte according to Examples A1 to A4, in which fluorine (F) was attached for Al³⁺ to have the coordination number of 5 or 6 (CN=5, or 6), but Al³⁺ cation with no fluorine, AlCl₄⁻, had the coordination number of 4 like NaAlCl₄. Accordingly, the coordination number of aluminum in the amorphous phase is presumed to be 5⁻ or 6⁻, and if a heterogeneous unit having 5⁻ or 6⁻ coordinated Al³⁺ is introduced, a local structural disorder may be generated. Accordingly, Al(Cl, F)n with the heterogeneous coordination number may secure high ionic conductivity due to the amorphous phase by inducing a locally-induced Na+ concentration and pores due to various ration of cations to anions.

### Experimental Example 10: Precursor Consumption Trend Analysis XRD

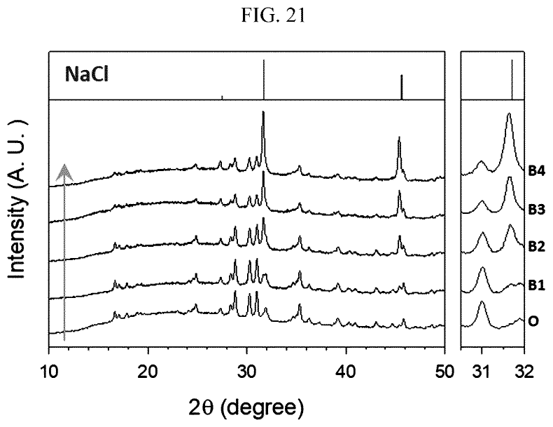

FIG. 21 shows the results of XRD analysis of the solid electrolytes of Examples B1 to B4 and Comparative Example O. XRD patterns were collected using a Rigaku MiniFlex600 diffractometer with Cu K_{α} radiation (λ=1.5406 Å). XRD cells including samples were mounted on an XRD diffractometer and measured at 40 kV and 15 mA.

Referring to FIG. 21, as an NaF input ratio increased from Example B1 to Example B4, an XRD peak corresponding to NaCl instead of NaF was confirmed to increase. Referring to the results, in the process of forming the composites for a solid electrolyte for a sodium all-solid-state battery, NaF was confirmed to be preferentially consumed in a reaction with AlCl₃.

Although the embodiments of the present invention have been described above, those skilled in the art can make various modifications and changes to the present invention by adding, changing, deleting or adding constituting elements, etc., without departing from the spirit of the present invention as set forth in the patent claims, and this will also be included within the scope of the rights of the present invention.

What is claimed is:

1. A composite for a solid electrolyte for a sodium all-solid-state battery, comprising
sodium metal tetrachloride (NaMCl₄),
wherein the metal (M) represents a Group 13 element on the periodic table, and
the composite includes an amorphous phase.

2. The composite of claim 1, wherein
the composite further includes sodium fluoride (NaF).

3. The composite of claim 1, wherein
the metal (M) includes boron (B), aluminum (Al), gallium (Ga), indium (In), thallium (Tl), nihonium (Nh), or a combination thereof.

4. The composite of claim 1, wherein
the sodium metal tetrachloride includes sodium aluminum tetrachloride (NaAlCl₄).

5. The composite of claim 1, wherein
the amorphous phase includes an M—F bond.

6. The composite of claim 2, wherein
the composite includes about 10 parts by mole to about 150 parts by mole of the sodium fluoride (NaF) based on 100 parts by mole of sodium metal tetrachloride (NaMCl₄).

7. The composite of claim 1, wherein
the composite includes about 50 wt % to about 90 wt % of the amorphous phase based on a total weight of the composite.

8. The composite of claim 1, wherein
the composite has an ionic conductivity of about 7.5×10⁻⁶ S/cm to about 5.0×10⁻⁵ S/cm at 30° C.

9. The composite of claim 1, wherein
the composite has an ionic conductivity of about 1.0×10⁻⁵ to about 5.0×10⁻⁵ S/cm at 30° C.

10. The composite of claim 2, wherein
the composite has a peak in the range of about −30 ppm to about −250 ppm in ¹⁹F MAS NMR analysis.

11. The composite of claim 5, wherein
the composite has a peak with a median peak value in the range of about −130 ppm to about −150 ppm in ¹⁹F MAS NMR analysis.

12. The composite of claim 5, wherein
a median value of the peak is about −130 ppm to about −150 ppm, and a full width at half maximum (FWHM) of the peak is about 80 ppm to about 95 ppm.

13. The composite of claim 5, wherein
fluorine (F) in the M—F bond has a bridging fluorine structure.

14. A sodium all-solid-state battery comprising the composite for a solid electrolyte for a sodium all-solid-state battery of claim 1.

15. The sodium all-solid-state battery of claim 14, wherein
the sodium all-solid-state battery includes a positive electrode layer; a negative electrode layer; and a solid electrolyte layer between the positive electrode layer and the negative electrode layer; wherein at least one of the positive electrode layer, the negative electrode layer, and the solid electrolyte layer includes the composite.

16. The sodium all-solid-state battery of claim 15, wherein
the solid electrolyte layer includes a positive electrode electrolyte layer on the positive electrode layer and a negative electrolyte layer on the negative electrode layer,
wherein the composite is included in at least one of the positive electrode layer and the positive electrode electrolyte layer.

17. The sodium all-solid-state battery of claim 16, wherein
the composite is included in the positive electrode layer and the positive electrode electrolyte layer.

18. A method for manufacturing composite for a solid electrolyte for a sodium all-solid-state battery, comprising
performing a ball milling for a mixture of sodium fluoride (NaF) and metal chloride (MCl₃), wherein the metal (M) of the metal chloride (MCl₃) is a Group 13 element of the periodic table.

19. The method of claim 18, wherein
the mixture includes about 10 parts by mole to about 200 parts by mole of metal chloride (MCl₃) based on 100 parts by mole of sodium fluoride (NaF).
